(19) United States
(12) Patent Application Publication
(10) Pub. No.: US 2019/0026107 A1
(43) Pub. Date: Jan. 24, 2019

(54) SOURCE CODE COMPARISON APPARATUS AND COMPUTER READABLE RECORDING MEDIUM

(71) Applicant: MITSUBISHI ELECTRIC CORPORATION, Chiyoda-ku, Tokyo (JP)

(72) Inventors: Ryo KASHIWAGI, Tokyo (JP); Yuki HIKAWA, Tokyo (JP); Katsuhiko NAKAMURA, Tokyo (JP); Natsuko FUJII, Tokyo (JP); Takanari FUJIMOTO, Tokyo (JP)

(73) Assignee: MITSUBISHI ELECTRIC CORPORATION, Chiyoda-ku, Tokyo (JP)

(21) Appl. No.: 16/066,019

(22) PCT Filed: Dec. 30, 2015
(86) PCT No.: PCT/JP2015/086586

§ 371 Date: Jun. 25, 2018

(51) Int. Cl. G06F 8/73

(52) U.S. Cl. CPC G06F 8/73

(57) ABSTRACT

A detailed analysis unit generates, with respect to pre-change source code and post-change source code, a detailed condition list for each set of a function included in each piece of source code and a call condition that is met when the function is called. The detailed condition list associates an executable statement included in the function, a detailed precondition that is met before the executable statement is executed under the call condition, and a detailed postcondition that is met after the executable statement is executed under the call condition with each other. A comparison unit generates a variation list based on a pre-change detailed condition list and a post-change detailed condition list. The variation list includes information for identifying an executable statement that differs in at least one of the detailed precondition and the detailed postcondition between the pre-change source code and the post-change source code.

### TECHNICAL FIELD

The present invention relates to a technique to, when a change is made to software, identify a portion that is affected by the change.

### BACKGROUND ART

When a change is made to a portion of software, a portion different from the changed portion may be sometimes affected by the change. Omission of a correction of the portion affected by the change may become a factor for causing failure. Therefore, it is necessary to identify the portion affected by the change.

In development of large-scale software, visually searching for a portion that is affected by a change from among a large amount of source code is inefficient, and, therefore, searching by a visual task leads to an increase in number of working processes. Moreover, searching by a visual task is likely to overlook a portion that is affected by a change, so that omission of a correction of the overlooked portion arises. Thus, searching by a visual task may become a factor for causing failure. Accordingly, it is requested to efficiently and exhaustively identify portions that are affected by a change.

Patent Literature 1 describes a method of extracting a change-affected portion with use of a dependence relationship between a function and a variable. Specifically, it describes a method of extracting a change-affected range with a dependence strength weighted.

However, in the method described in Patent Literature 1, with regard to a function that is affected by a change among functions having a dependence relationship, it is necessary to visually check a description in the function.

Patent Literature 2 and Patent Literature 3 describe a method of extracting a change-affected portion with use of execution paths.

Specifically, Patent Literature 2 describes a method of detecting a test case that is affected by a change by using a change in value range of an output item in each execution path.

Moreover, Patent Literature 3 describes a method of detecting a test case that is affected by a change by using a change in value range of an input item in each execution path.

However, the method described in Patent Literature 2 or Patent Literature 3 can identify a change-affected portion at a granularity of a function, but cannot extract a change-affected portion on a row-by-row basis.

### CITATION LIST

### Patent Literature

Patent Literature 1: JP-A-2013-125466
Patent Literature 2: JP-A-2015-090616
Patent Literature 3: JP-A-2014-191652

### Non Patent Literature

Non-Patent Literature 1: TechMatrix Corporation, “Lattix—Architecture Analysis Tool—”, the Internet (URL: https://www.techmatrix.co.jp/QUALITY/LATTIX/), searched on Dec. 2, 2015

### SUMMARY OF INVENTION

### Technical Problem

An object of the invention is to, when a change is made to software, identify a portion that is affected by the change.

### Solution to Problem

A source code comparison apparatus according to the present invention includes:
a detailed analysis unit to generate, with respect to pre-change source code and post-change source code, a detailed condition list in which, for each set of a function included in each piece of source code and a call condition that is met when the function is called, an executable statement included in the function, a detailed precondition that is met before the executable statement is executed under the call condition, and a detailed postcondition that is met after the executable statement is executed under the call condition are associated with each other; and
a comparison unit to generate a variation list including information for identifying an executable statement that differs in at least one of the detailed precondition and the detailed postcondition between the pre-change source code and the post-change source code based on a pre-change detailed condition list, which is the detailed condition list generated with respect to the pre-change source code, and a post-change detailed condition list, which is the detailed condition list generated with respect to the post-change source code.

### Advantageous Effects of Invention

According to the invention, an executable statement that differs in at least one of a detailed precondition and a detailed postcondition between pre-change source code and post-change source code can be identified as a portion that is affected by a change.

### BRIEF DESCRIPTION OF DRAWINGS

FIG. 1 is a configuration diagram of a source code comparison apparatus 100 in an embodiment 1.

FIG. 2 is a flowchart of a source code comparison method in the embodiment 1.

FIG. 3 is a flowchart of analysis processing (S200) in the embodiment 1.

FIG. 4 is a diagram illustrating pre-change source code 101 in the embodiment 1.

FIG. 5 is diagram illustrating a pre-change simple condition file 191 in the embodiment 1.

FIG. 6 is diagram illustrating a pre-change simple condition list 192 of a “func” function in the embodiment 1.

FIG. 7 is a flowchart of entry analysis processing (S220) in the embodiment 1.

FIG. 8 is a diagram illustrating a dependence list 193 in the embodiment 1.

FIG. 9 is a diagram illustrating an entry function list 194 in the embodiment 1.

FIG. 10 is a flowchart of detailed analysis processing (S230) in the embodiment 1.

FIG. 11 is a flowchart of recurrence analysis processing (S300) in the embodiment 1.

FIG. 12 is a flowchart of immediately preceding evaluation processing (S310) in the embodiment 1.

FIG. 13 is a diagram illustrating an example of a work precondition PREV and a work postcondition AFTER, taken after the immediately preceding evaluation processing (S310) is performed, in the embodiment 1.

FIG. 14 is a flowchart of variable evaluation processing (S320) in the embodiment 1.

FIG. 15 is a diagram illustrating an example of a work precondition PREV and a work postcondition AFTER, taken after the variable evaluation processing (S320) is performed, in the embodiment 1.

FIG. 16 is a flowchart of recurrence evaluation processing (S330) in the embodiment 1.

FIG. 17 is a diagram illustrating an example of a work precondition PREV and a work postcondition AFTER, taken after the recurrence evaluation processing (S330) is performed, in the embodiment 1.

FIG. 18 is a flowchart of contradiction evaluation processing (S340) in the embodiment 1.

FIG. 19 is a diagram illustrating an example of a work precondition PREV and a work postcondition AFTER, taken after the contradiction evaluation processing (S340) is performed, in the embodiment 1.

FIG. 20 is a diagram illustrating a configuration of a pre-change detailed condition file 195 in the embodiment 1.

FIG. 21 is a diagram illustrating a pre-change detailed condition list 196 of an “invoke” function (void) in the embodiment 1.

FIG. 22 is a diagram illustrating a pre-change detailed condition list 196 of a “func” function (x=0) in the embodiment 1.

FIG. 23 is a diagram illustrating a pre-change detailed condition list 196 of an “arraySize” function (x=0) in the embodiment 1.

FIG. 24 is a diagram illustrating a pre-change detailed condition list 196 of an “arraySize” function (x=1) in the embodiment 1.

FIG. 25 is a diagram illustrating a pre-change detailed condition list 196 of an “arraySize” function (x=2) in the embodiment 1.

FIG. 26 is a diagram illustrating a pre-change detailed condition list 196 of an “arraySize” function (x=3) in the embodiment 1.

FIG. 27 is a diagram illustrating a pre-change detailed condition list 196 of an “arraySize” function (x=4) in the embodiment 1.

FIG. 28 is a flowchart of comparison processing (S130) in the embodiment 1.

FIG. 29 is a diagram illustrating a pre-change join condition file 197 in the embodiment 1.

FIG. 30 is a diagram illustrating a pre-change join condition list 198 of a “func” function in the embodiment 1.

FIG. 31 is a diagram illustrating post-change source code 101 in the embodiment 1.

FIG. 32 is a diagram illustrating a post-change join condition file 197 in the embodiment 1.

FIG. 33 is a diagram illustrating a post-change join condition list 198 of a “func” function in the embodiment 1.

FIG. 34 is a diagram illustrating a variation list 199 in the embodiment 1.

FIG. 35 is a configuration diagram of a source code comparison apparatus 100 in an embodiment 2.

FIG. 36 is a flowchart of recurrence analysis processing (S300) in the embodiment 2.

FIG. 37 is a diagram illustrating an exclusion list 103 in the embodiment 2.

FIG. 38 is a diagram illustrating a pre-change detailed condition list 196 of an “invoke” function (void) in the embodiment 2.

FIG. 39 is a diagram illustrating a pre-change detailed condition list 196 of a “func” function (x=0) in the embodiment 2.

FIG. 40 is a configuration diagram of a source code comparison apparatus 100 in an embodiment 3.

FIG. 41 is a flowchart of recurrence analysis processing (S300) in the embodiment 3.

FIG. 42 is a flowchart of additional evaluation processing (S350) in the embodiment 3.

FIG. 43 is a diagram illustrating an addition list 104 in the embodiment 3.

FIG. 44 is a diagram illustrating a pre-change detailed condition list 196 of an “invoke” function (void) in the embodiment 3.

FIG. 45 is a diagram illustrating a pre-change detailed condition list 196 of a “func” function (x=0) in the embodiment 3.

FIG. 46 is a hardware configuration diagram of the source code comparison apparatus 100 in each embodiment.

### DESCRIPTION OF EMBODIMENTS

### Embodiment 1

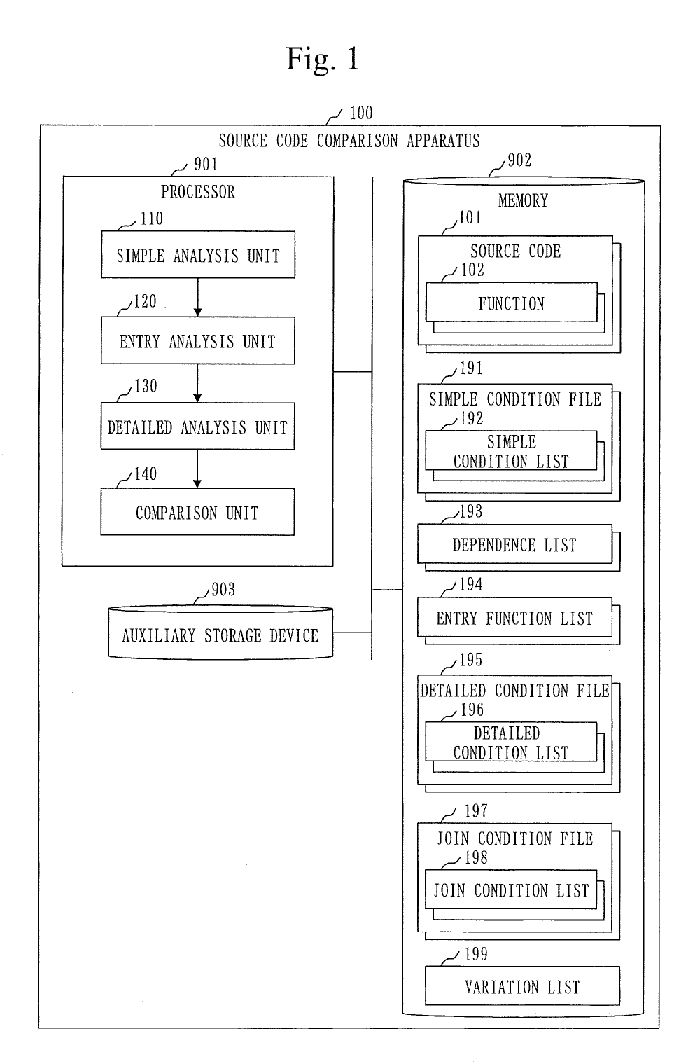

A source code comparison apparatus 100 which compares pre-change source code and post-change source code with each other is described based on FIG. 1 to FIG. 34.

### Description of Configuration

A configuration of the source code comparison apparatus 100 is described based on FIG. 1.

The source code comparison apparatus 100 is a computer including hardware such as a processor 901, a memory 902, and an auxiliary storage device 903. The processor 901 is connected to other hardware via a signal line.

The processor 901 is an integrated circuit (IC) which performs processing, and controls other hardware. More specifically, the processor 901 is a CPU, a DSP, or a GPU. CPU is an abbreviation for central processing unit, DSP is an abbreviation for digital signal processor, and GPU is an abbreviation for graphics processing unit.

The memory 902 is a volatile storage device. The memory 902 is also called a main storage device or a main memory. More specifically, the memory 902 is a random access memory (RAM).

The auxiliary storage device 903 is a non-volatile storage device. More specifically, the auxiliary storage device 903 is a ROM, an HDD, or a flash memory. ROM is an abbreviation for read-only memory, and HDD is an abbreviation for hard disk drive.

The source code comparison apparatus 100 includes, as elements of a functional configuration, “units” such as a simple analysis unit 110, an entry analysis unit 120, a detailed analysis unit 130, and a comparison unit 140. The function of a “unit” is implemented by software. The function of a “unit” is described below.

A program for implementing the function of a “unit” is stored in the auxiliary storage device 903. The program for implementing the function of a “unit” is loaded onto the memory 902 and is then executed by the processor 901.

Furthermore, an operating system (OS) is stored in the auxiliary storage device 903. At least a part of the OS is loaded onto the memory 902 and is then executed by the processor 901.

Thus, the processor 901 executes the program for implementing the function of a “unit” while executing the OS.

Data obtained by executing the program for implementing the function of a “unit” is stored in a storage device such as the memory 902, the auxiliary storage device 903, a register included in the processor 901, or a cache memory included in the processor 901. These storage devices function as a storage unit which stores data. Furthermore, the source code comparison apparatus 100 can include a plurality of processors 901, and the plurality of processors 901 can execute the program for implementing the function of a “unit” in cooperation with each other.

Data to be used, generated, input or output, or transmitted or received by the source code comparison apparatus 100 is stored in the memory 902.

More specifically, the following pieces of data are stored in the memory 902. Pre-change source code 101 and post-change source code 101 are stored in the memory 902. A simple condition file 191, a dependence list 193, an entry function list 194, a detailed condition file 195, and a join condition file 197, which correspond to the pre-change source code 101, are stored in the memory 902. A simple condition file 191, a dependence list 193, an entry function list 194, a detailed condition file 195, and a join condition file 197, which correspond to the post-change source code 101, are stored in the memory 902. A variation list 199 is stored in the memory 902. The contents of pieces of data stored in the memory 902 are described below.

Hardware obtained by integrating the processor 901, the memory 902, and the auxiliary storage device 903 is referred to as a “processing circuitry”.

“Unit” can be replaced with “processing” or “process”. The function of a “unit” can also be implemented by firmware.

The program for implementing the function of a “unit” can be stored in a non-volatile storage medium, such as a magnetic disc, an optical disc, or a flash memory.

### Description of Operation

Operations of the source code comparison apparatus 100 are equivalent to a source code comparison method.

Moreover, procedures of the source code comparison method are equivalent to procedures of a source code comparison program.

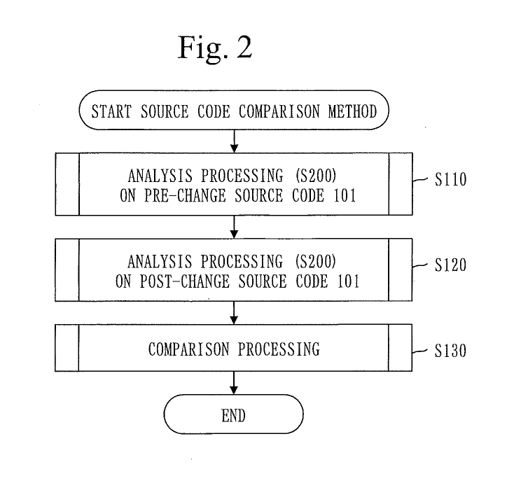

The source code comparison method is described based on FIG. 2.

Step S110 is analysis processing (S200) on the pre-change source code 101.

In step S110, the source code comparison apparatus 100 performs the analysis processing (S200) on the pre-change source code 101.

The source code 101 includes pieces of source code for respective functions 102. Thus, the source code 101 includes a plurality of functions 102. Each function 102 includes one or more instruction statements.

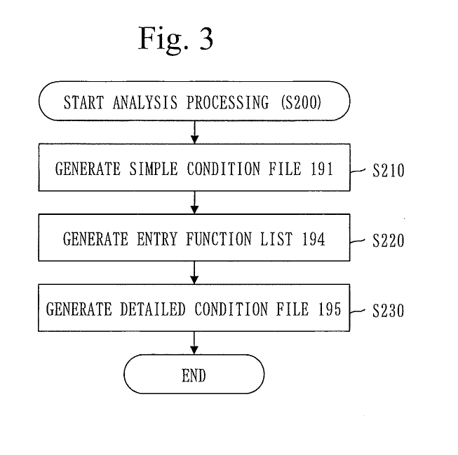

The analysis processing (S200) is described based on FIG. 3.

Step S210 is simple analysis processing.

In step S210, the simple analysis unit 110 generates a simple condition file 191 based on the source code 101.

The simple condition file 191 is a file including simple condition lists 192 for respective functions 102 included in the source code 101.

The simple condition list 192 is a list in which an executable statement included in the function 102, a simple precondition that is met before the executable statement is executed, and a simple postcondition that is met after the executable statement is executed are associated with each other.

The executable statement is an instruction statement in which the content of processing is specified in the instruction statements included in the function 102. More specifically, instruction statements such as an arithmetic statement in which an arithmetic expression is specified, an assignment statement for assigning a value to a variable, and a call statement for calling a function are included in the executable statement. On the other hand, instruction statements such as a definition statement for defining a variable and a control statement for controlling a processing flow are not included in the executable statement. However, an arithmetic statement, an assignment statement, and a call statement which are specified in the control statement are included in the executable statement. A specific control statement includes, for example, a FOR statement and an IF statement. The FOR statement is one of loop statements for iterating processing with the same content. The IF statement is one of condition branch statements for branching processing according to a condition.

More specifically, the simple analysis unit 110 generates a simple condition file 191 by processing the source code 101 with an algorithm that is based on Hoare logic or abstract interpretation. Hoare logic and abstract interpretation are methods for calculating a precondition and a postcondition.

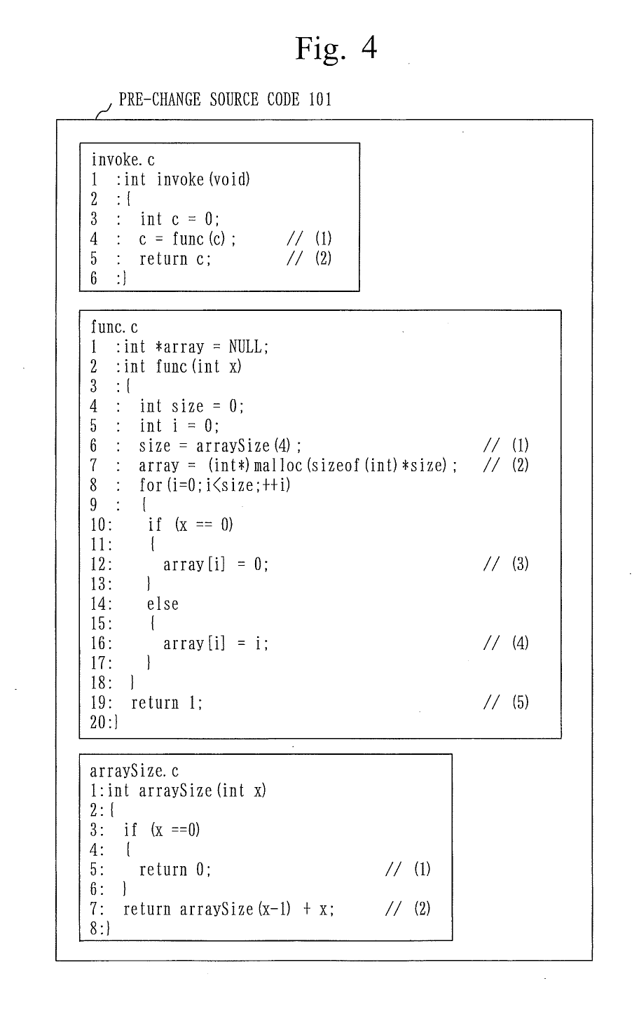

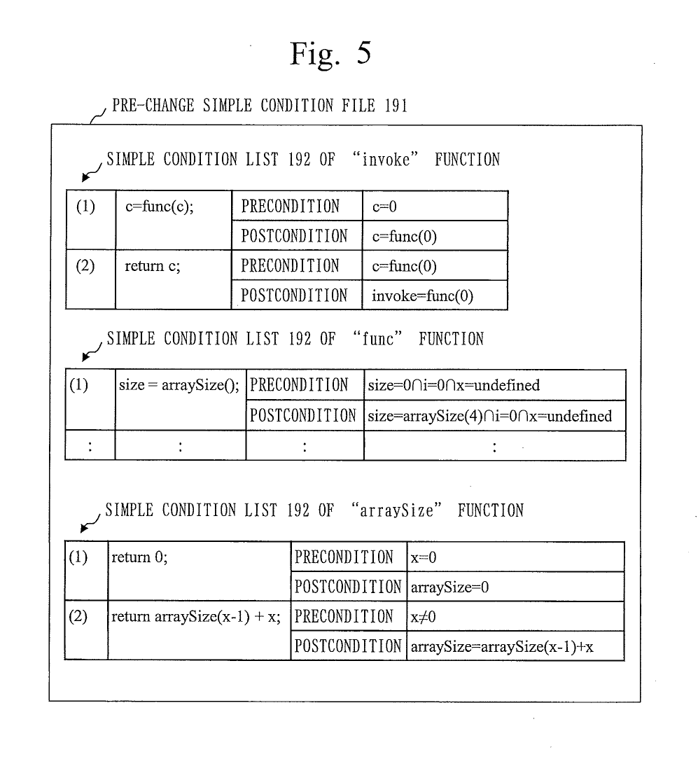

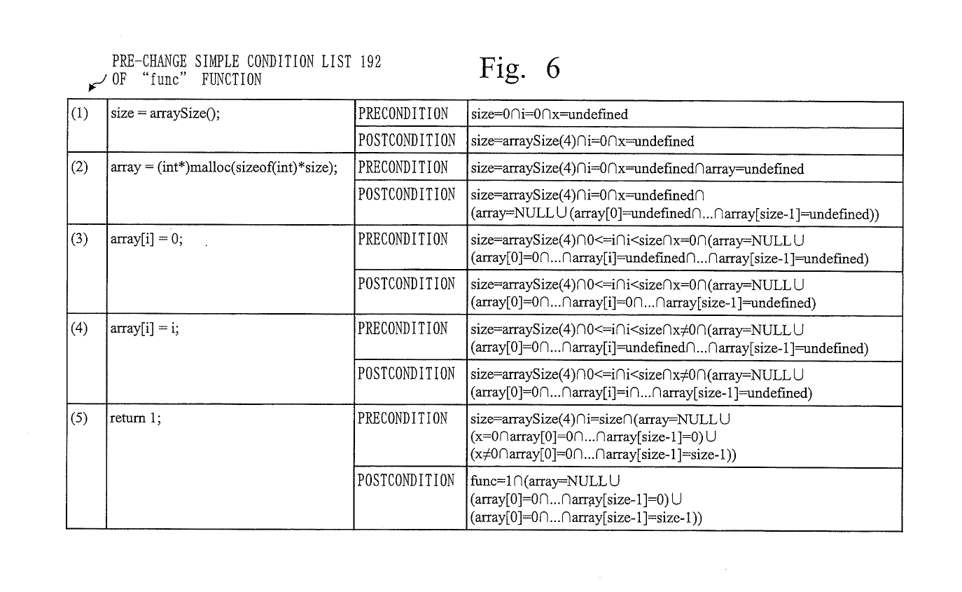

When the simple analysis processing (S210) is performed on source code 101 illustrated in FIG. 4, a simple condition file 191 such as that illustrated in FIG. 5 and FIG. 6 is generated.

The source code 101 illustrated in FIG. 4 includes respective pieces of pre-change source code of the “invoke” function, the “func” function, and the “arraySize” function.

The simple condition file 191 illustrated in FIG. 5 includes respective simple condition lists 192 of the “invoke” function, the “func” function, and the “arraySize” function.

The entirety of the simple condition list 192 of the “func” function is illustrated in FIG. 6.

The first column of the simple condition list 192 indicates a number for identifying an executable statement. This number is assigned to the figure of the source code 101.

The second column of the simple condition list 192 indicates an executable statement.

The third column of the simple condition list 192 distinguishes between a precondition and a postcondition.

The fourth column of the simple condition list 192 indicates a precondition or a postcondition. The precondition and the postcondition are represented by one conditional expression or joining of a plurality of conditional expressions. One conditional expression or joining of a plurality of conditional expressions representing the precondition and the postcondition is also referred to as a logical expression. The precondition and the postcondition in the simple condition list 192 are equivalent to a simple precondition and a simple postcondition.

Referring back to FIG. 3, step S220 is described.

Step S220 is entry analysis processing.

In step S220, the entry analysis unit 120 generates an entry function list 194 by identifying an entry function from the source code 101.

The entry function list 194 is a file indicating an entry function. The entry function is a function which calls at least any one of functions but is not called from any function.

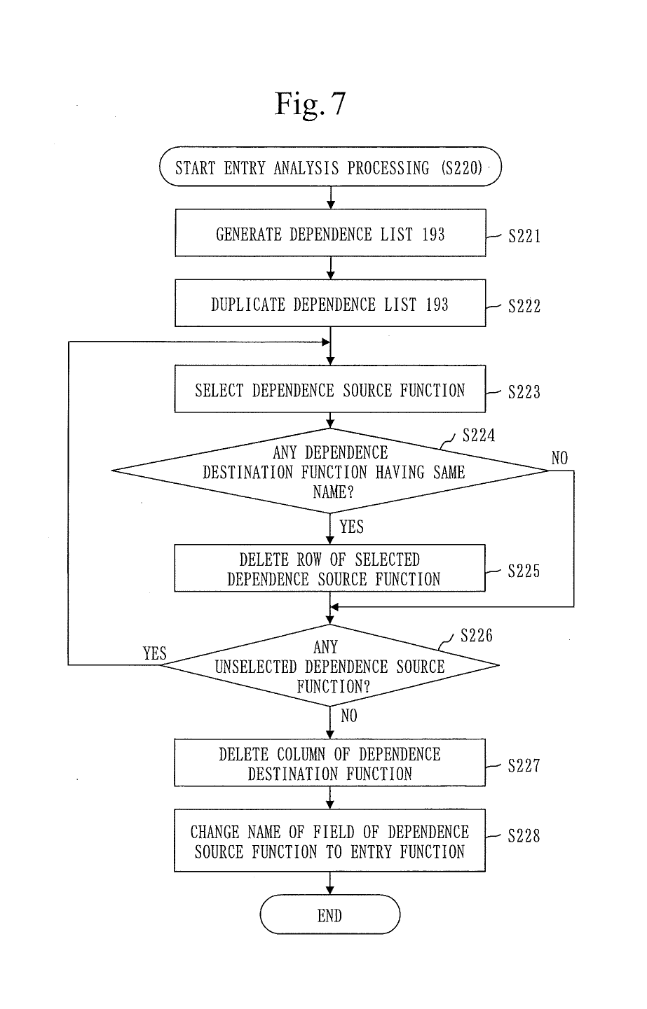

The entry analysis processing (S220) is described based on FIG. 7.

In step S221, the entry analysis unit 120 generates a dependence list 193.

The dependence list 193 is a list in which a dependence source function, which is a function that calls a function, and a dependence destination function, which is a function that is called by the dependence source function, are associated with each other.

More specifically, the entry analysis unit 120 generates the dependence list 193 by performing the following processing for each function 102.

First, the entry analysis unit 120 extracts a call statement from source code of the function 102 by performing syntax analysis and character analysis on the source code of the function 102.

Next, the entry analysis unit 120 identifies a function that is called by the extracted call statement by performing syntax analysis and character analysis on the extracted call statement.

Then, the entry analysis unit 120 registers the function 102 as a dependence source function with the dependence list 193, and registers the identified function as a dependence destination function with the dependence list 193.

Furthermore, a tool that is on the market can be used as the entry analysis unit 120. A specific tool includes a tool introduced in a web page cited in [Non-Patent Literature 1]. Upon inputting of source code, this tool generates and outputs a dependence list.

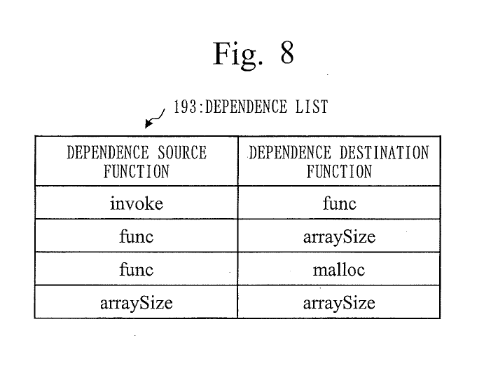

The dependence list 193 illustrated in FIG. 8 is generated by the processing in step S221 being performed on the source code 101 illustrated in FIG. 4.

Referring back to FIG. 7, the description proceeds from step S222.

In step S222, the entry analysis unit 120 duplicates the dependence list 193. The duplicated dependence list 193 serves as a source of the entry function list 194.

In step S223, the entry analysis unit 120 selects one of unselected dependence source functions from the duplicated dependence list 193.

More specifically, the entry analysis unit 120 selects a dependence source function one by one in order from the beginning of the duplicated dependence list 193.

In step S224, the entry analysis unit 120 determines whether a dependence destination function having the same name as that of the selected dependence source function is included in the duplicated dependence list 193.

If a dependence destination function having the same name as that of the selected dependence source function is included in the duplicated dependence list 193, processing proceeds to step S225.

If a dependence destination function having the same name as that of the selected dependence source function is not included in the duplicated dependence list 193, processing proceeds to step S226.

In step S225, the entry analysis unit 120 deletes a row including the selected dependence source function from the duplicated dependence list 193.

In step S226, the entry analysis unit 120 determines whether there is an unselected dependence source function.

If there is an unselected dependence source function, processing returns to step S223.

If there is no unselected dependence source function, processing proceeds to step S227.

In step S227, the entry analysis unit 120 deletes a column of dependence destination functions from the duplicated dependence list 193.

In step S228, the entry analysis unit 120 changes the name of a field of dependence source function to entry function.

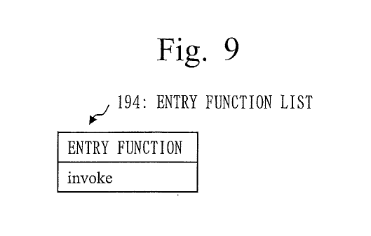

The entry function list 194 illustrated in FIG. 9 is generated by the processing in step S222 to step S228 being performed on the dependence list 193 illustrated in FIG. 8.

Referring back to FIG. 3, step S230 is described.

Step S230 is detailed analysis processing.

In step S230, the detailed analysis unit 130 generates a detailed condition file 195 based on the source code 101, the simple condition file 191, and the entry function list 194.

The detailed condition file 195 is a file including a detailed condition list 196 for each set of a function 102 included in the source code 101 and a call condition that is met when the function 102 is called.

The detailed condition list 196 is a list in which an executable statement included in the function 102, a detailed precondition that is met before the executable statement is executed under the call condition, and a detailed postcondition that is met after the executable statement is executed under the call condition are associated with each other.

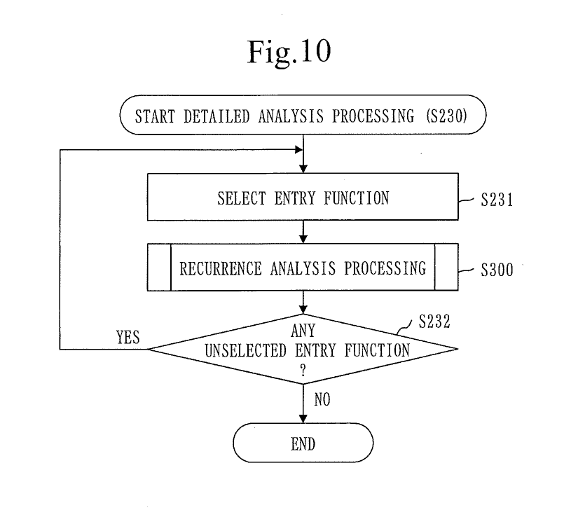

The detailed analysis processing (S230) is described based on FIG. 10.

In step S231, the detailed analysis unit 130 selects one of unselected entry functions from the entry function list 194.

More specifically, the detailed analysis unit 130 selects an entry function one by one in order from the beginning of the entry function list 194.

Step S300 is recurrence analysis processing.

In step S300, the detailed analysis unit 130 sets the entry function as an initial target function, and generates a detailed condition list 196 of the entry function and a detailed condition list 196 of a function that is called in association with execution of the entry function.

The recurrence analysis processing (S300) is described separately.

In step S232, the detailed analysis unit 130 determines whether there is an unselected entry function.

If there is an unselected entry function, processing returns to step S231.

If there is no unselected entry function, the detailed analysis processing (S230) ends.

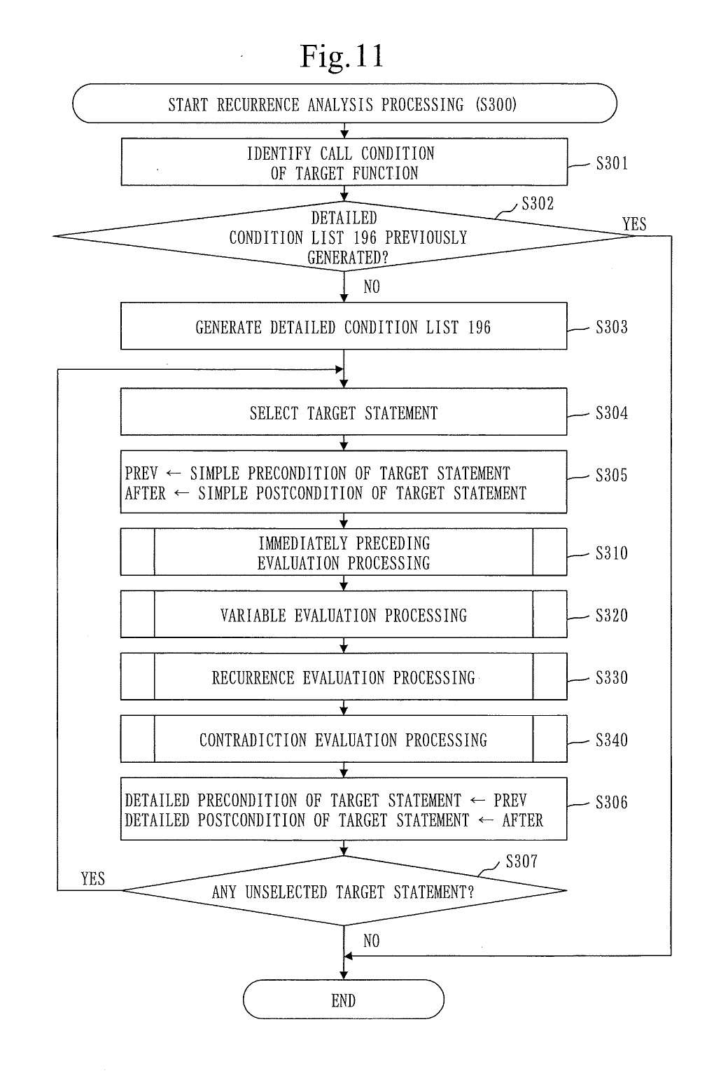

The recurrence analysis processing (S300) is described based on FIG. 11.

In step S301, the detailed analysis unit 130 identifies a call condition that is met when the target function is called. The target function is a function 102 serving as a target with respect to which a detailed condition list 196 is generated.

A specific call condition includes a value that is passed as an argument to the above-mentioned function and a value that is set to a global variable used in the above-mentioned function.

In a case where the target function is an entry function, the detailed analysis unit 130 identifies a call condition of the entry function by performing syntax analysis and character analysis on source code of the entry function.

In a case where the target function is a function other than the entry function, the detailed analysis unit 130 identifies, as a call condition of the above-mentioned function, a value that is passed as an argument to the above-mentioned function by performing syntax analysis and character analysis on a call statement which calls the above-mentioned function. Moreover, the detailed analysis unit 130 identifies, as a call condition of the above-mentioned function, a value that is set to a global variable used in the above-mentioned function by performing syntax analysis and character analysis on the above-mentioned function and a function including the above-mentioned call statement.

In step S302, the detailed analysis unit 130 determines whether a detailed condition list 196 corresponding to a set of the target function and the call condition identified in step S301 is previously generated.

If a detailed condition list 196 corresponding to the above-mentioned set is previously generated, the recurrence analysis processing (S300) ends.

If a detailed condition list 196 corresponding to the above-mentioned set is not yet generated, processing proceeds to step S303.

In step S303, the detailed analysis unit 130 generates a blank detailed condition list 196 in association with the set of the target function and the call condition identified in step S301.

More specifically, the detailed analysis unit 130 generates a blank detailed condition list 196 in association with a set of the name of the target function and a value that is passed as an argument to the target function.

In step S304, the detailed analysis unit 130 selects an executable statement in order in which executable statements are executed from the simple condition list 192 of the target function. The executable statement that is selected is referred to as a target statement.

More specifically, the detailed analysis unit 130 selects an executable statement one by one as a target statement in order from the beginning of the simple condition list 192 of the target function.

In step S305, the detailed analysis unit 130 acquires a simple precondition of the target statement and a simple postcondition of the target statement from the simple condition list 192 of the target function.

Then, the detailed analysis unit 130 sets the simple precondition of the target statement to a work precondition PREV and sets the simple postcondition of the target statement to a work postcondition AFTER.

The work precondition PREV is a variable to which a detailed precondition of a target statement that is registered with a detailed condition list 196 corresponding to the set of the target function and the above-mentioned call condition is set.

The work postcondition AFTER is a variable to which a detailed postcondition of a target statement that is registered with a detailed condition list 196 corresponding to the set of the target function and the above-mentioned call condition is set.

Step S310 is immediately preceding evaluation processing.

In step S310, in a case where an immediately preceding statement, which is an executable statement that is executed prior to the target statement, is included in the target function, the detailed analysis unit 130 acquires a detailed postcondition of the immediately preceding statement from the detailed condition list 196 corresponding to the set of the target function and the above-mentioned call condition. Then, the detailed analysis unit 130 adds the detailed postcondition of the immediately preceding statement to the work precondition PREV.

Details of the immediately preceding evaluation processing (S310) are described separately.

Step S320 is variable evaluation processing.

In step S320, in a case where a condition including a specific element is included in the work precondition PREV or the work postcondition AFTER, the detailed analysis unit 130 replaces the above-mentioned element with a value included in the call condition of the target function or a value included in the detailed postcondition of the immediately preceding statement. The specific element is an element that is replaced with a value included in the call condition of the target function or a value included in the detailed postcondition of the immediately preceding statement.

Details of the variable evaluation processing (S320) are described separately.

Step S330 is recurrence evaluation processing.

In step S330, in a case where the target statement is an executable statement for calling a function, the detailed analysis unit 130 generates a detailed condition list 196 about a call destination function, which is a function that is called by the target statement. Then, the detailed analysis unit 130 identifies a condition that is met after the call destination function is executed based on the detailed condition list 196 of the call destination function, and replaces a condition set to the work postcondition AFTER with the identified condition.

Details of the recurrence evaluation processing (S330) are described separately.

Step S340 is contradiction evaluation processing.

In step S340, the detailed analysis unit 130 determines whether there is a contradiction in the work precondition PREV. If determining that there is a contradiction in the work precondition PREV, the detailed analysis unit 130 deletes a condition set to the work precondition PREV and a condition set to the work postcondition AFTER.

Details of the contradiction evaluation processing (S340) are described separately.

In step S306, the detailed analysis unit 130 registers a condition set to the work precondition PREV as a detailed precondition of the target statement with the detailed condition list 196 generated in step S303.

Moreover, the detailed analysis unit 130 registers a condition set to the work postcondition AFTER as a detailed postcondition of the target statement with the detailed condition list 196 generated in step S303.

In step S307, the detailed analysis unit 130 determines whether there is an executable statement that is not yet selected as a target statement.

If there is an executable statement that is not yet selected as a target statement, processing returns to step S304.

If there is no executable statement that is not yet selected as a target statement, the recurrence analysis processing (S300) ends.

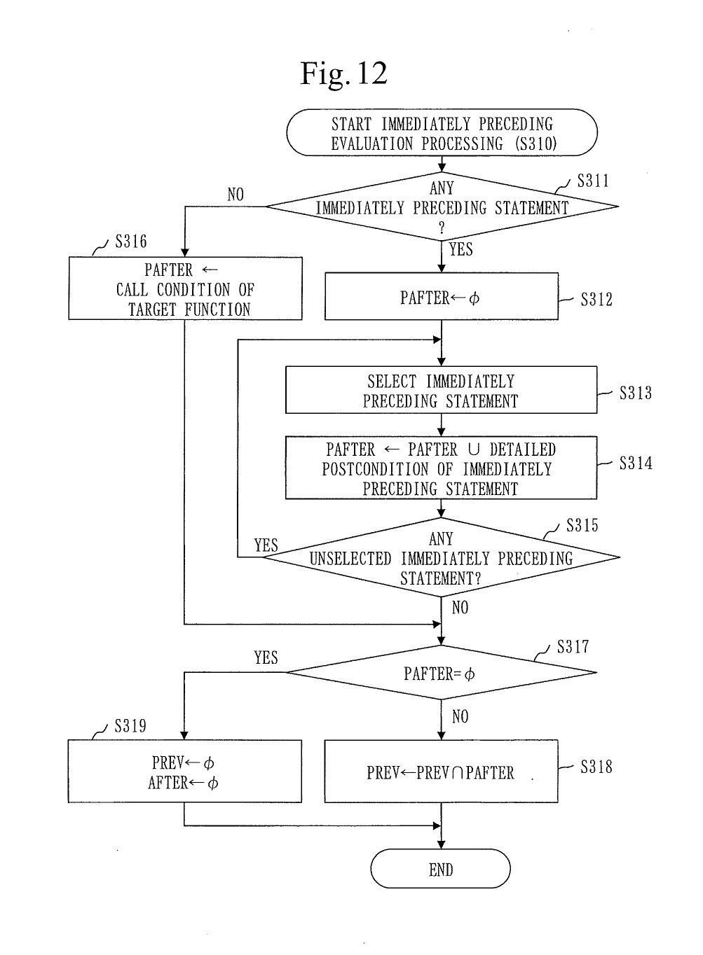

The immediately preceding evaluation processing (S310) is described based on FIG. 12.

In step S311, the detailed analysis unit 130 determines whether there is an immediately preceding statement relative to the target statement in the target function.

More specifically, the detailed analysis unit 130 determines whether there is an immediately preceding statement relative to the target statement in the target function by performing syntax analysis and character analysis on source code of the target function.

In a case where an element occurring immediately before the target statement is a block of a conditional branching statement, a plurality of immediately preceding statements is present. More specifically, in a case where an element occurring immediately before the target statement is a block of an IF statement, the final executable statement of a TRUE path and the final executable statement of an ELSE path serve as immediately preceding statements. The TRUE path is processing that is performed when a condition specified by the IF statement is met. The ELSE path is processing that is performed when a condition specified by the IF statement is not met. If there is an immediately preceding statement relative to the target statement in the target function, processing proceeds to step S312.

If there is no immediately preceding statement relative to the target statement in the target function, processing proceeds to step S316.

In step S312, the detailed analysis unit 130 sets unconditional ϕ to an immediately preceding condition PAFTER.

The immediately preceding condition PAFTER is a variable to which a detailed postcondition of the immediately preceding statement is set.

The unconditional ϕ means that there is no specific condition that is met.

In step S313, the detailed analysis unit 130 selects one of unselected immediately preceding statements.

In step S314, the detailed analysis unit 130 acquires a detailed postcondition of the selected immediately preceding statement from the detailed condition list 196 corresponding to the set of the target function and the above-mentioned call condition. Then, the detailed analysis unit 130 adds the acquired detailed postcondition to the immediately preceding condition PAFTER. More specifically, the detailed analysis unit 130 adds a symbol indicating a sum set and the acquired detailed postcondition to a condition set to the immediately preceding condition PAFTER.

The immediately preceding condition PAFTER obtained after addition of the acquired detailed postcondition is a sum set of the condition set to the immediately preceding condition PAFTER and the acquired detailed postcondition.

In step S315, the detailed analysis unit 130 determines whether there is an unselected immediately preceding statement.

If there is an unselected immediately preceding statement, processing returns to step S313.

If there is no unselected immediately preceding statement, processing proceeds to step S317.

In step S316, the detailed analysis unit 130 sets a call condition of the target function to the immediately preceding condition PAFTER.

In step S317, the detailed analysis unit 130 determines whether the immediately preceding condition PAFTER is the unconditional ϕ.

If the immediately preceding condition PAFTER is not the unconditional ϕ, processing proceeds to step S318.

If the immediately preceding condition PAFTER is the unconditional ϕ, processing proceeds to step S319.

In step S318, the detailed analysis unit 130 adds the immediately preceding condition PAFTER to the work precondition PREV of the target statement. More specifically, the detailed analysis unit 130 adds a symbol indicating a product set and a condition set to the immediately preceding condition PAFTER to a condition set to the work precondition PREV of the target statement.

The work precondition PREV obtained after addition of the immediately preceding condition PAFTER is a product set of the condition set to the work precondition PREV and the condition set to the immediately preceding condition PAFTER.

In step S319, the detailed analysis unit 130 updates the work precondition PREV of the target statement and the work postcondition AFTER of the target statement to the unconditional ϕ.

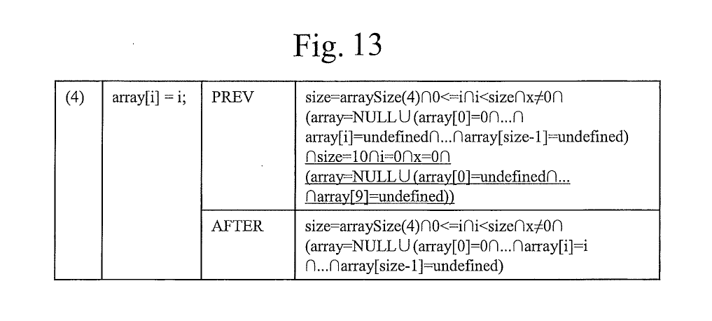

FIG. 13 illustrates the work precondition PREV and the work postcondition AFTER obtained after the immediately preceding evaluation processing (S310) is performed with an executable statement of (4) in the simple condition list 192 of the “func” function illustrated in FIG. 6 set as the target statement. The call condition of the “func” function is “x=0”. The immediately preceding statement of the executable statement of (4) is an executable statement of (2). An underline portion in FIG. 13 is a condition added as the detailed postcondition of the immediately preceding statement.

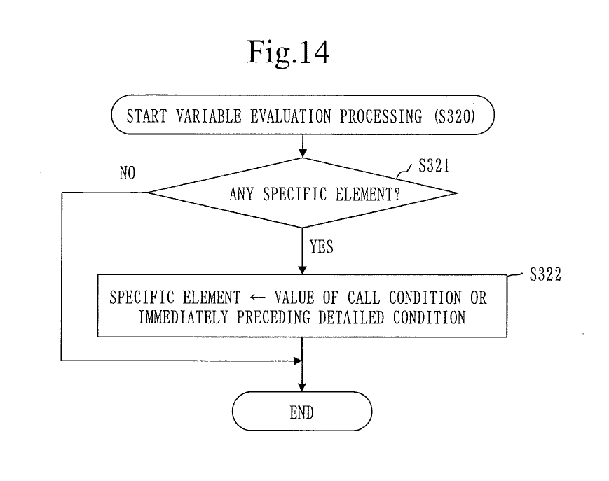

The variable evaluation processing (S320) is described based on FIG. 14.

In step S321, the detailed analysis unit 130 determines whether a specific condition is included in the work precondition PREV or the work postcondition AFTER of the target statement.

The specific condition is a condition including a specific element.

The specific element is an element that is replaced with a value included in the call condition of the target function or a value included in the detailed postcondition of the immediately preceding statement.

More specifically, the detailed analysis unit 130 performs the determination in the following way.

The detailed analysis unit 130 acquires a detailed postcondition of the immediately preceding statement from the detailed condition list 196 corresponding to the set of the target function and the above-mentioned call condition.

Then, the detailed analysis unit 130 performs the following processing for each condition included in the work precondition PREV or the work postcondition AFTER of the target statement.

The detailed analysis unit 130 acquires a variable included in the left-hand side of a conditional expression representing the condition, and searches for a conditional expression in which a variable having the same name as that of the acquired variable is included in the left-hand side thereof from the call condition of the target function and the detailed postcondition of the immediately preceding statement.

If the above-mentioned conditional expression is included in the call condition of the target function or the detailed postcondition of the immediately preceding statement, the detailed analysis unit 130 determines that the specific condition is included in the work precondition PREV or the work postcondition AFTER of the target statement.

If a condition including the specific element is included in the work precondition PREV or the work postcondition AFTER, processing proceeds to step S322.

If a condition including the specific element is included in neither the work precondition PREV nor the work postcondition AFTER, the variable evaluation processing (S320) ends.

In step S322, the detailed analysis unit 130 replaces the specific element with a value included in the call condition of the target function or a value included in the detailed postcondition of the immediately preceding statement.

A variable or an indefinite value included in the right-hand side of the specific condition serves as the specific element. The indefinite value is every value which the variable can take. Term “undefined” mentioned in the figures of the simple condition list 192 or the detailed condition list 196 means an indefinite value.

The value included in the right-hand side of the above-mentioned conditional expression searched for in step S321 among the values included in the call condition of the target function or the detailed postcondition of the immediately preceding statement serves as a value with which the specific element is replaced.

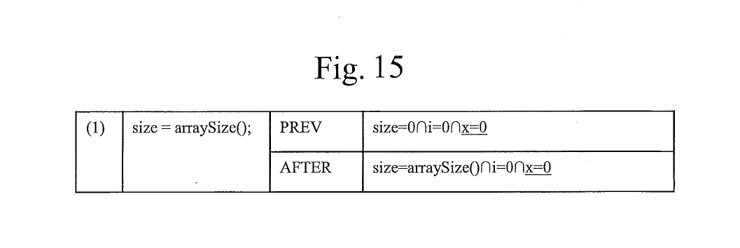

FIG. 15 illustrates the work precondition PREV and the work postcondition AFTER obtained after the variable evaluation processing (S320) is performed with an executable statement of (1) in the simple condition list 192 of the “func” function illustrated in FIG. 6 set as the target statement. An underline portion illustrated in FIG. 15 is a portion obtained by replacement.

In FIG. 4, the value of an argument x of the “func” function called by the “invoke” function is “0”. In other words, one of call conditions of the “func” function is “x=0”. Therefore, “x=undefined”, which is equivalent to the specific condition in (1) of FIG. 6, is replaced with “x=0” in FIG. 15. In “x=undefined”, “x” is equivalent to a variable included in the left-hand side of the specific condition, and “undefined” is equivalent to the specific element.

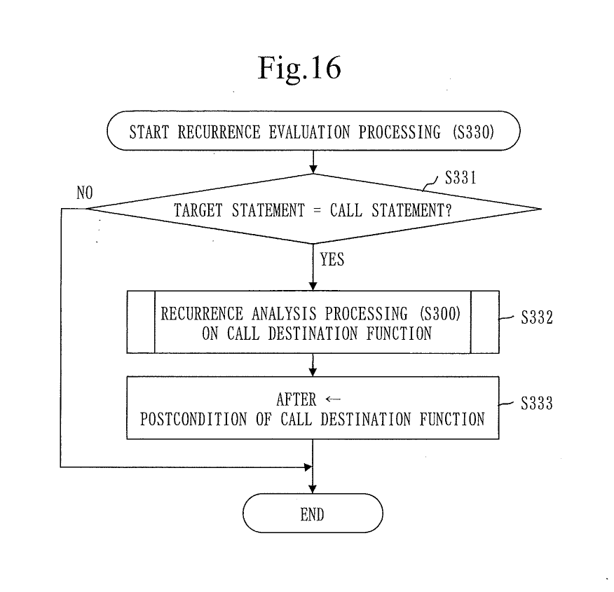

The recurrence evaluation processing (S330) is described based on FIG. 16.

In step S331, the detailed analysis unit 130 determines whether the target statement is a call statement. The call statement is an executable statement for calling a function.

More specifically, the detailed analysis unit 130 determines whether the syntax of the target statement is the syntax of a call statement by performing syntax analysis on the target statement. If the syntax of the target statement is the syntax of a call statement, the detailed analysis unit 130 determines that the target statement is a call statement.

If the target statement is a call statement, processing proceeds to step S332.

If the target statement is not a call statement, the recurrence evaluation processing (S330) ends.

In step S332, the detailed analysis unit 130 performs recurrence analysis processing (S300) with a call destination function, which is a function that is called with the target statement, set as a new target function.

With this recurrence analysis processing (S300) performed, a detailed condition list 196 corresponding to a set of the call destination function and an argument of the call destination function in the target statement is generated.

In step S333, the detailed analysis unit 130 identifies a condition that is met after the call destination function is executed based on the detailed condition list 196 generated in step S332. Then, the detailed analysis unit 130 replaces the condition set to the work postcondition AFTER of the target statement with the identified condition.

More specifically, the detailed analysis unit 130 performs the following processing.

First, the detailed analysis unit 130 determines whether the final executable statement included in the detailed condition list 196 generated in step S332 is a return statement. If the above-mentioned final executable statement is a return statement, the detailed analysis unit 130 acquires a return value of the call destination function from a detailed postcondition of the return statement.

Next, the detailed analysis unit 130 acquires a detailed postcondition of the final executable statement of the call destination function from the detailed condition list 196 generated in step S332.

Then, the detailed analysis unit 130 replaces the condition set to the work postcondition AFTER of the target statement with a product set of the return value of the call destination function and the detailed postcondition of the final executable statement of the call destination function.

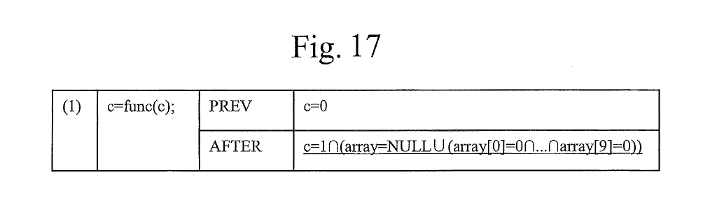

FIG. 17 illustrates a work precondition PREV and a work postcondition AFTER obtained after the recurrence evaluation processing (S330) is performed with an executable statement of (1) included in the simple condition list 192 of the “invoke” function illustrated in FIG. 5 set as a target statement. An underline portion illustrated in FIG. 17 is a portion obtained by replacement.

In (1) of FIG. 5, the target statement is “c=func(c)”, and the simple precondition of the target statement is “c=0”. In this case, the call destination function is a “func” function, and the call condition is “c=O”. When the “func” function is executed under this call condition, a return value obtained in the return statement of the “func” function is “c=l”. Therefore, in FIG. 17, the work postcondition AFTER is the one replaced with a condition including “c=1”. In the work postcondition AFTER illustrated in FIG. 17, a condition included behind “c=1∩” is a detailed postcondition of the final executable statement (return statement) of the “func” function.

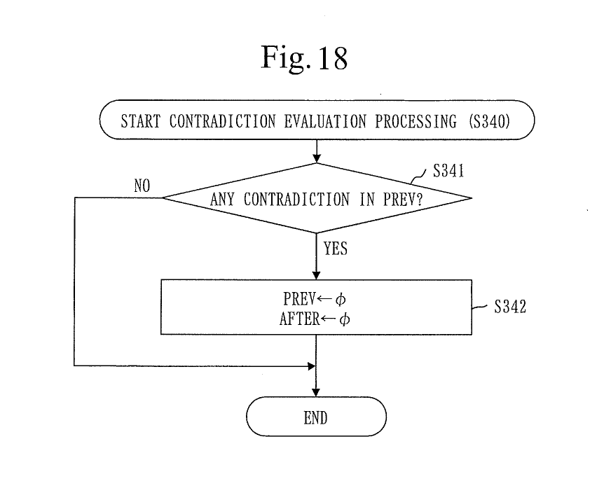

The contradiction evaluation processing (S340) is described based on FIG. 18.

In step S341, the detailed analysis unit 130 determines whether there is a contradiction in the work precondition PREV of the target statement.

More specifically, the detailed analysis unit 130 determines whether a plurality of conditional expressions in which a variable having the same name is included as a left-hand side element is included in the work precondition PREV. If a plurality of conditional expressions in which a variable having the same name is included as a left-hand side element is included in the work precondition PREV, the detailed analysis unit 130 compares operators and right-hand sides of the plurality of conditional expressions. Then, if the operators and right-hand sides do not coincide with each other, the detailed analysis unit 130 determines that there is a contradiction in the work precondition PREV.

If there is a contradiction in the work precondition PREV of the target statement, processing proceeds to step S342.

If there is no contradiction in the work precondition PREV of the target statement, the contradiction evaluation processing (S340) ends.

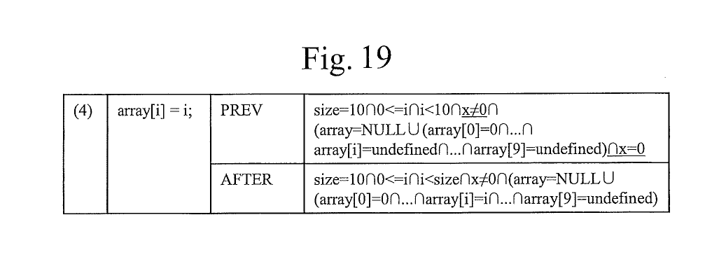

FIG. 19 illustrates an example of a work precondition PREV having a contradiction.

In FIG. 19, the work precondition PREV includes two conditional expressions in which a variable x is included as a left-hand side element. One conditional expression includes “x≠0” and the other conditional expression includes “x=0”, and both conditional expressions are connected by logical conjunction. Thus, a conditional expression obtained by connecting both conditional expressions is “x=0∩x≠0”. On the other hand, since the operator and right-hand side of one conditional expression is “≠0” and the operator and right-hand side of the other conditional expression is “=0”, both do not coincide with each other. Accordingly, it is determined that there is a contradiction in this work precondition PREV.

Referring back to FIG. 18, step S342 is described.

In step S342, the detailed analysis unit 130 updates each of the condition set to the work precondition PREV of the target statement and the condition set to the work postcondition AFTER of the target statement to the unconditional ϕ. This is because the work precondition PREV of the target statement having a contradiction results in the target statement not being reached even by execution of the target function.

In the above description, the details of the analysis processing (S200) have been described.

With the analysis processing (S200) performed, the detailed condition list 196 for each set of the function included in the source code 101 and the call condition of the function is generated.

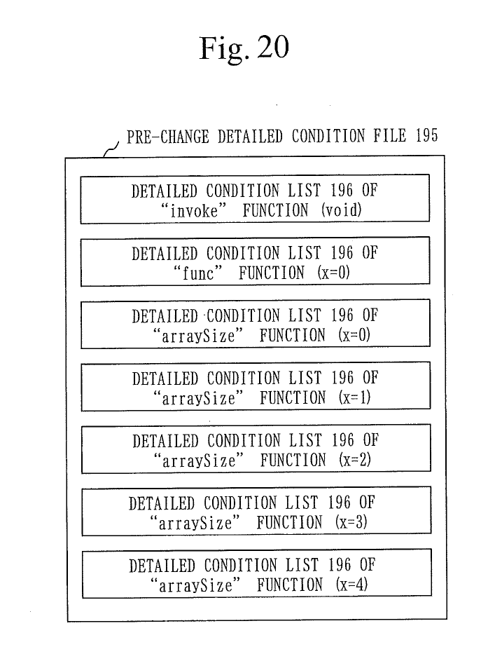

FIG. 20 illustrates a configuration of the detailed condition file 195 obtained by performing the analysis processing (S200) on the pre-change source code 101 illustrated in FIG. 4.

In FIG. 20, the detailed condition file 195 includes a detailed condition list 196 corresponding to a set of the “invoke” function and the call condition (void). Moreover, the detailed condition file 195 includes a detailed condition list 196 corresponding to a set of the “func” function and the call condition (x=0). Furthermore, the detailed condition file 195 includes detailed condition lists 196 corresponding to respective sets of the “arraySize” function and the call conditions (x=0 to 4). “0 to 4” is a value range of arguments serving as call conditions. The value range is a range of possible values.

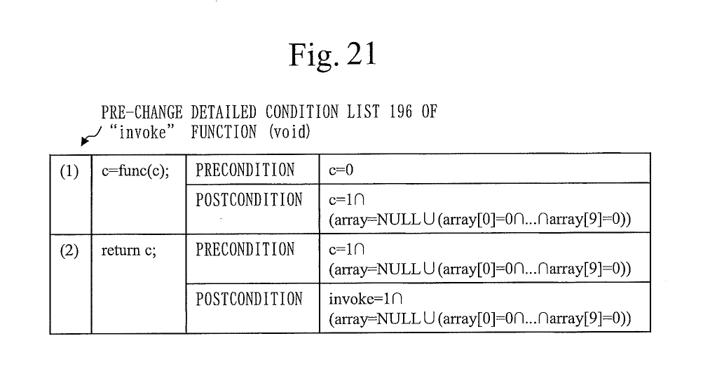

FIG. 21 illustrates the detailed condition list 196 corresponding to a set of the “invoke” function and the call condition (void).

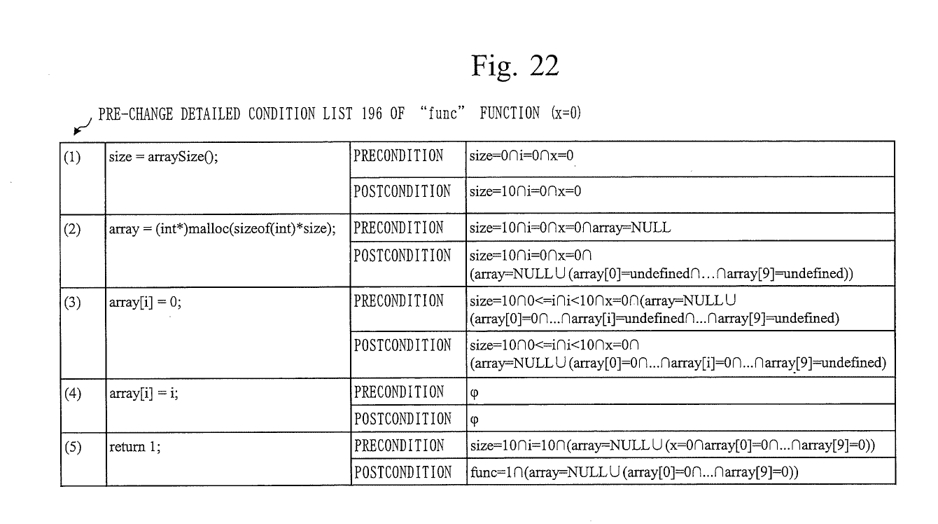

FIG. 22 illustrates the detailed condition list 196 corresponding to a set of the “func” function and the call condition (x=0).

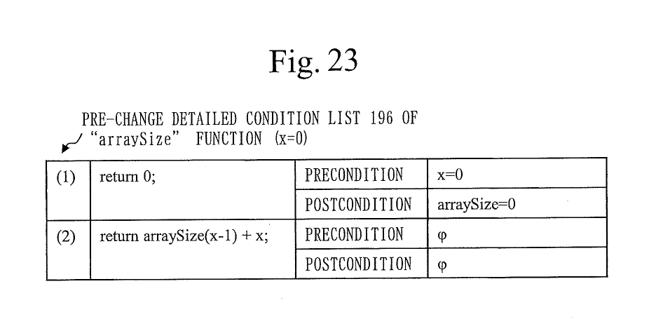

FIG. 23 illustrates the detailed condition list 196 corresponding to a set of the “arraySize” function and the call condition (x=0).

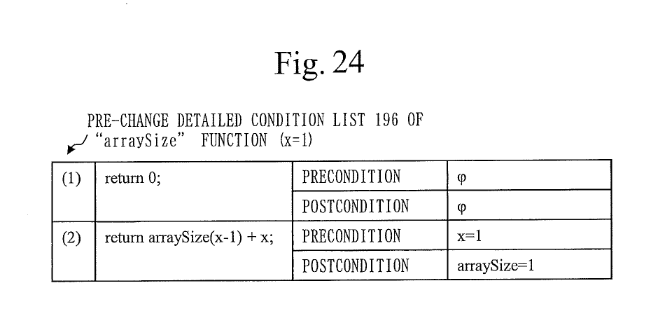

FIG. 24 illustrates the detailed condition list 196 corresponding to a set of the “arraySize” function and the call condition (x=1).

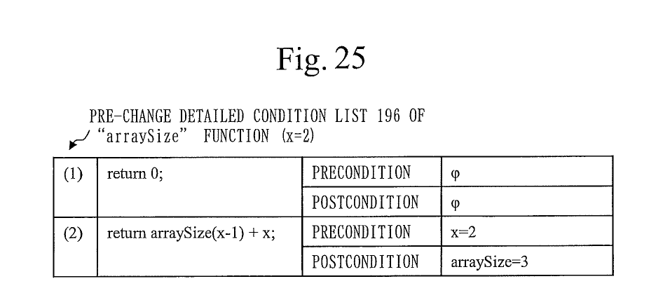

FIG. 25 illustrates the detailed condition list 196 corresponding to a set of the “arraySize” function and the call condition (x=2).

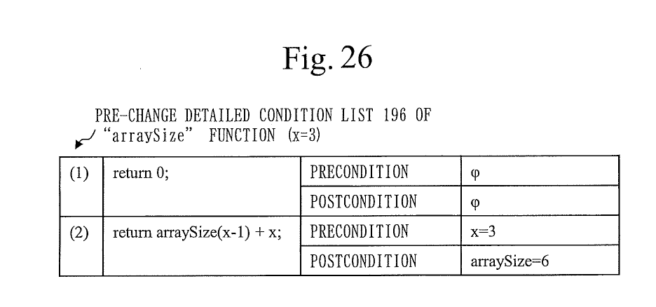

FIG. 26 illustrates the detailed condition list 196 corresponding to a set of the “arraySize” function and the call condition (x=3).

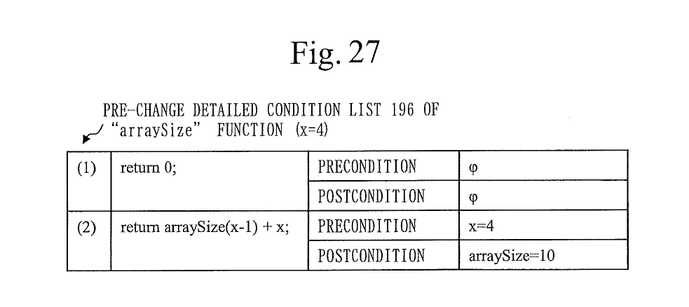

FIG. 27 illustrates the detailed condition list 196 corresponding to a set of the “arraySize” function and the call condition (x=4).

The first column of the detailed condition list 196 indicates a number for identifying an executable statement.

The second column of the detailed condition list 196 indicates an executable statement.

The third column of the detailed condition list 196 distinguishes between a precondition and a postcondition.

The fourth column of the detailed condition list 196 indicates a precondition or a postcondition. The precondition and the postcondition in the detailed condition list 196 are equivalent to a detailed precondition and a detailed postcondition.

Referring back to FIG. 2, the description proceeds from step S120.

Step S120 is analysis processing (S200) on the post-change source code 101. In step S120, the source code comparison apparatus 100 performs analysis processing (S200) on the post-change source code 101.

Step S130 is comparison processing.

In step S130, the comparison unit 140 generates a variation list 199 based on the pre-change detailed condition list 196 and the post-change detailed condition list 196.

The pre-change detailed condition list 196 is a detailed condition list 196 generated with respect to the pre-change source code 101.

The post-change detailed condition list 196 is a detailed condition list 196 generated with respect to the post-change source code 101.

The variation list 199 is a list including information for identifying an executable statement that differs in at least one of a detailed precondition and a detailed postcondition between the pre-change source code 101 and the post-change source code 101.

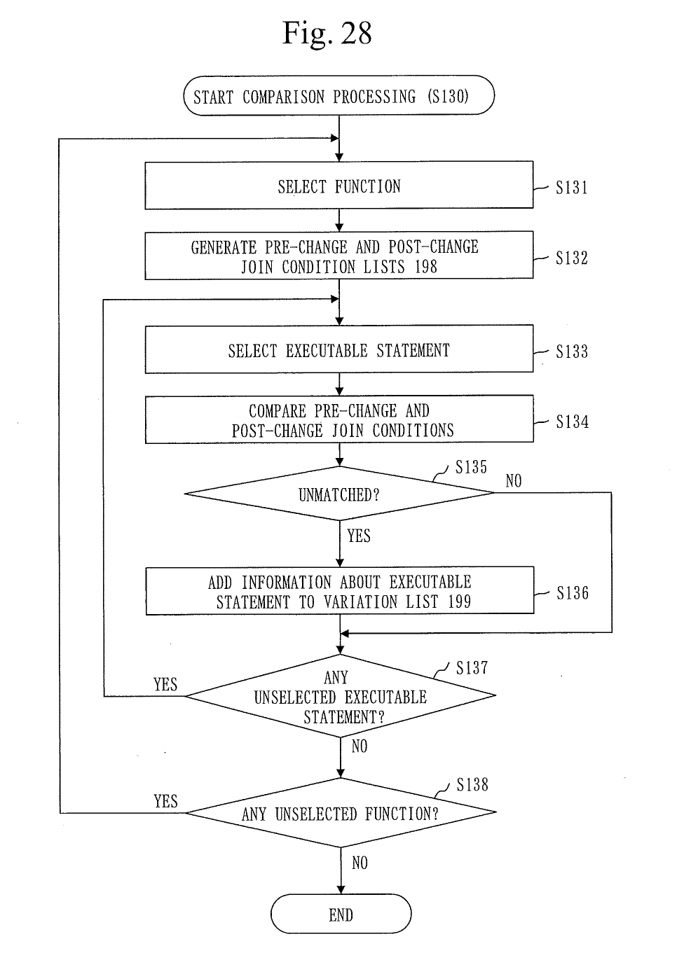

The comparison processing (S130) is described based on FIG. 28.

In step S131, the comparison unit 140 selects one of unselected functions from the pre-change source code 101 and the post-change source code 101.

In step S132, the comparison unit 140 generates a pre-change join condition list 198 of the selected function by joining the pre-change detailed condition lists 196 of the selected function.

Moreover, the comparison unit 140 generates a post-change join condition list 198 of the selected function by joining the post-change detailed condition lists 196 of the selected function.

The join condition list 198 is a list in which, for each function included in the source code 101, an executable statement included in the function, a join precondition that is met before the executable statement is executed, and a join postcondition that is met after the executable statement is executed are associated with each other.

More specifically, the comparison unit 140 generates a sum set of detailed preconditions and a sum set of detailed postconditions for each executable statement included in the detailed condition list 196. Then, the comparison unit 140 registers the sum set of detailed preconditions for each executable statement as a join precondition for each executable statement with the join condition list 198, and registers the sum set of detailed postconditions for each executable statement as a join postcondition for each executable statement with the join condition list 198.

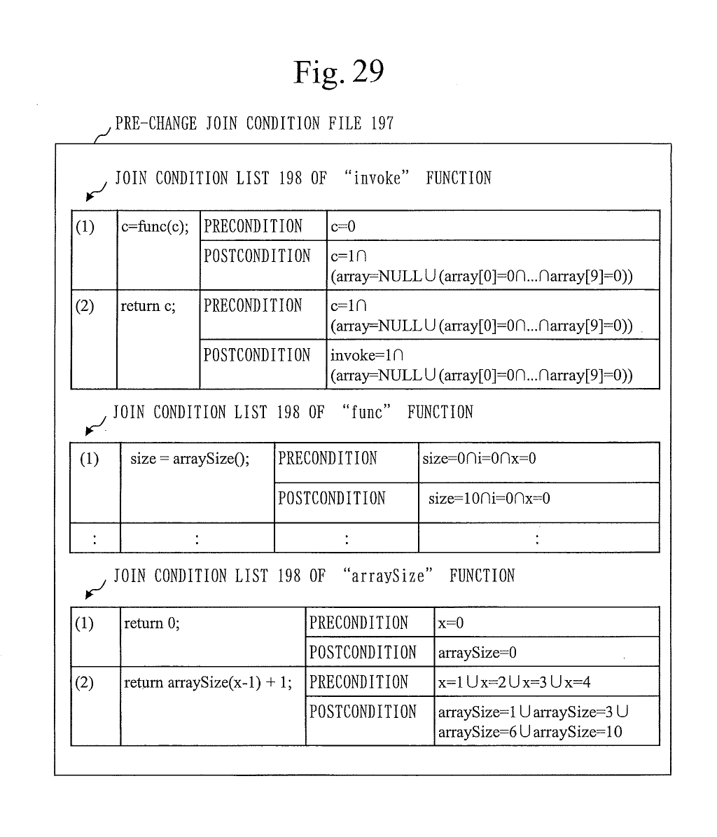

FIG. 29 illustrates a join condition file 197 including join condition lists 198 obtained from the detailed condition lists 196 illustrated in FIG. 21 to FIG. 27.

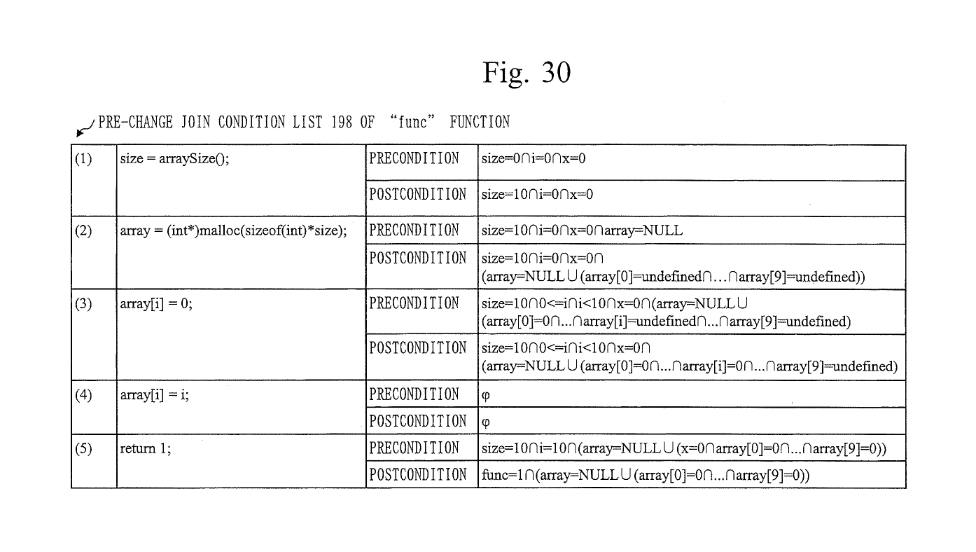

The join condition file 197 illustrated in FIG. 29 includes respective join condition lists 198 of the “invoke” function, “func” function, and “arraySize” function. The entirety of the join condition list 198 of the “func” function is illustrated in FIG. 30. The content of the join condition list 198 of the “invoke” function is the same as the content of the detailed condition list 196 corresponding to a set of the “invoke” function and the call condition (void). The content of the join condition list 198 of the “func” function is the same as the content of the detailed condition list 196 corresponding to a set of the “func” function and the call condition (x=0).

The first column of the join condition list 198 indicates a number for identifying an executable statement.

The second column of the join condition list 198 indicates an executable statement.

The third column of the join condition list 198 distinguishes a precondition or a postcondition.

The fourth column of the join condition list 198 indicates a precondition or a postcondition. The precondition and the postcondition in the join condition list 198 are equivalent to a join precondition and a join postcondition.

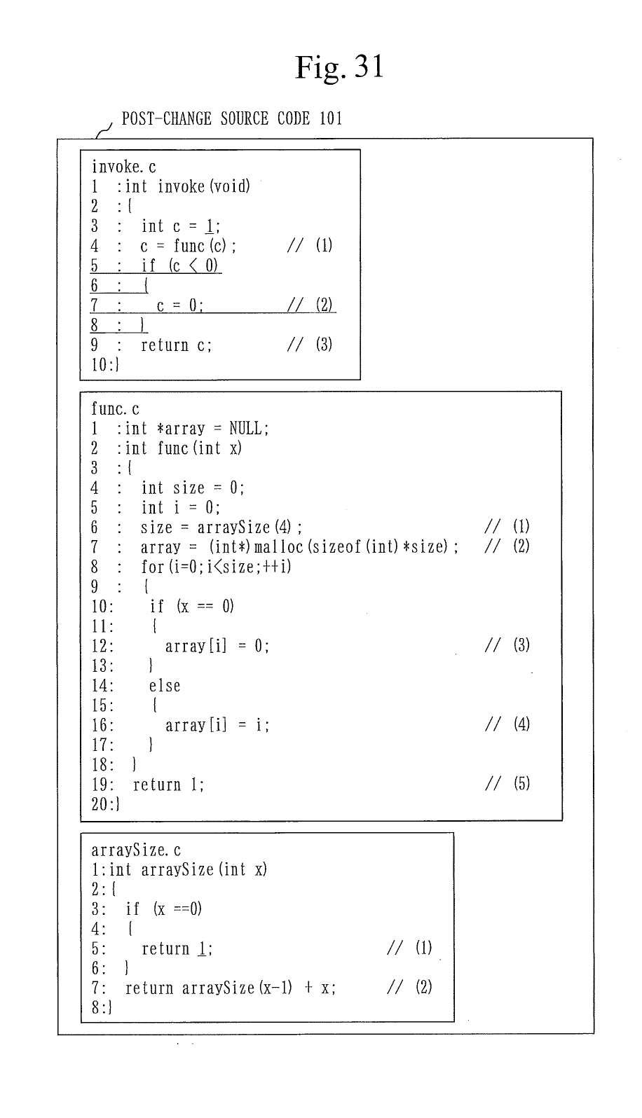

FIG. 31 illustrates post-change source code 101. In the source code 101 illustrated in FIG. 31, an underlined portion is a changed portion.

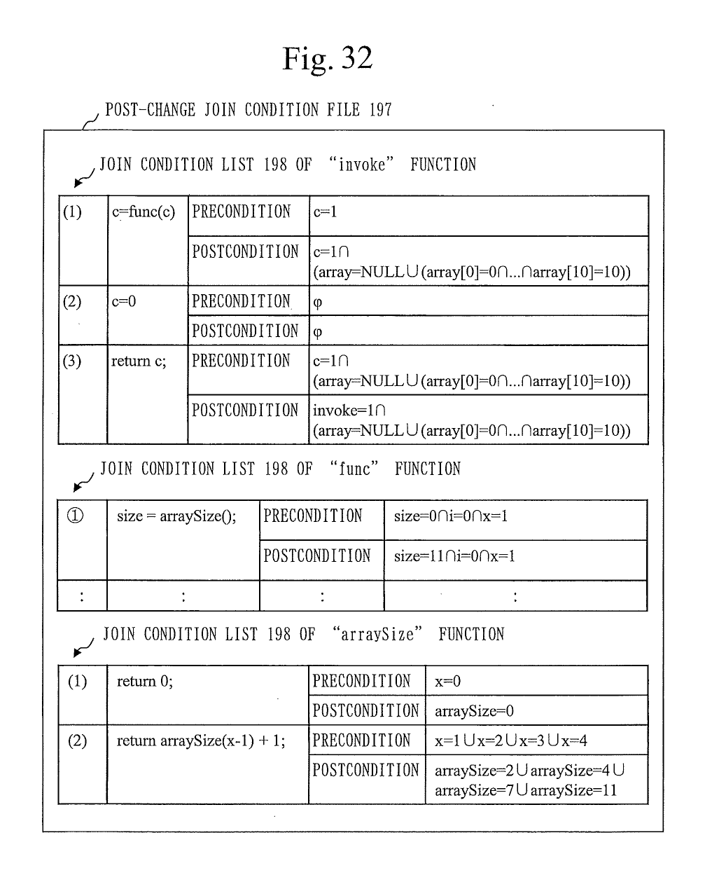

FIG. 32 illustrates a join condition file 197 that is obtained based on the source code 101 illustrated in FIG. 31.

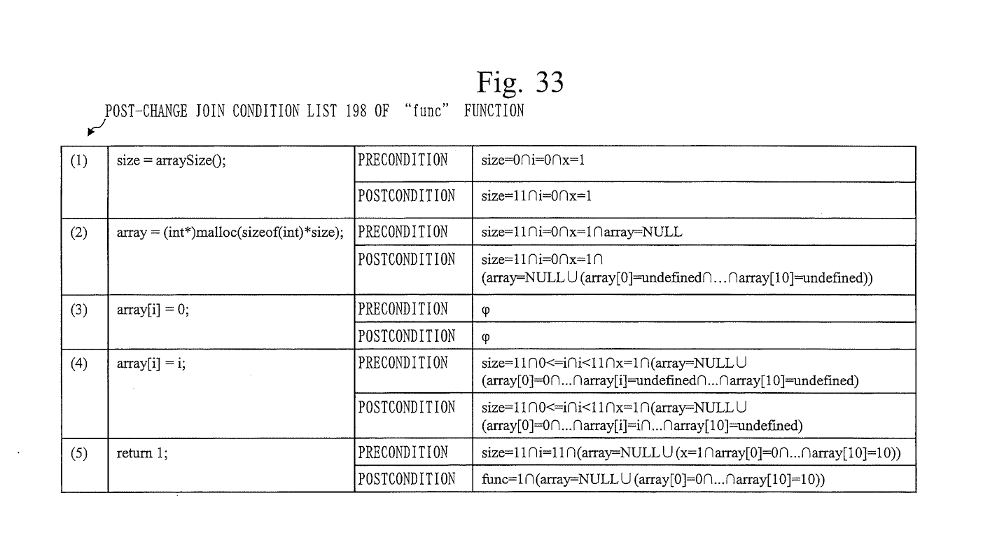

The join condition file 197 illustrated in FIG. 32 includes respective join condition lists 198 of the “invoke” function, “func” function, and “arraySize” function. The entirety of the join condition list 198 of the “func” function is illustrated in FIG. 33.

Referring back to FIG. 28, the description proceeds from step S133.

In step S133, the comparison unit 140 selects one of unselected executable statements from the pre-change join condition list 198 or the post-change join condition list 198.

In step S134, the comparison unit 140 acquires a join precondition and a join postcondition of the selected executable statement from each of the pre-change join condition list 198 and the post-change join condition list 198.

Then, the comparison unit 140 compares the join precondition acquired from the pre-change join condition list 198 and the join precondition acquired from the post-change join condition list 198 with each other. Moreover, the comparison unit 140 compares the join postcondition acquired from the pre-change join condition list 198 and the join postcondition acquired from the post-change join condition list 198 with each other.

In step S135, the comparison unit 140 determines whether the join preconditions subjected to comparison are unmatched. Moreover, the comparison unit 140 determines whether the join postconditions subjected to comparison are unmatched. If at least one of the set of the join preconditions subjected to comparison and the set of the join postconditions subjected to comparison is unmatched, processing proceeds to step S136.

If neither the set of the join preconditions subjected to comparison nor the set of the join postconditions subjected to comparison is unmatched, processing proceeds to step S137.

In step S136, the comparison unit 140 adds information about the selected executable statement to the variation list 199.

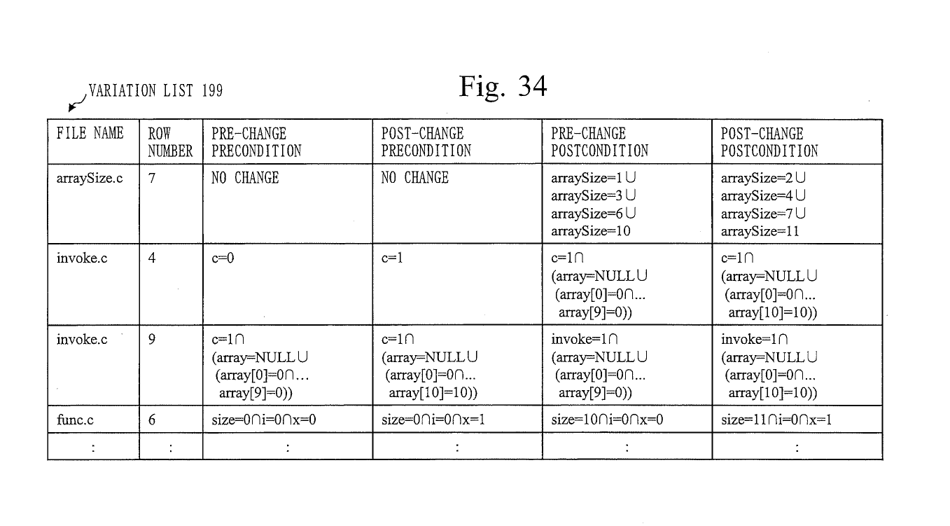

FIG. 34 illustrates a variation list 199 obtained by comparing the join condition lists 198 included in the join condition file 197 illustrated in FIG. 29 and the join condition lists 198 included in the join condition file 197 illustrated in FIG. 32 with each other.

In FIG. 34, the variation list 199 includes a field for the file name, a field for the row number, a field for the pre-change precondition, a field for the post-change precondition, a field for the pre-change postcondition, and a field for the post-change postcondition.

The field for the file name indicates the name of a file in which the source code of a function including the above-mentioned executable statement is described.

The field for the row number indicates the number of a row in which the above-mentioned executable statement is described in the post-change source code of the above-mentioned function.

The field for the pre-change precondition indicates a pre-change join precondition of the above-mentioned executable statement.

The field for the post-change precondition indicates a post-change join precondition of the above-mentioned executable statement.

The field for the pre-change postcondition indicates a pre-change join postcondition of the above-mentioned executable statement.

The field for the post-change postcondition indicates a post-change join postcondition of the above-mentioned executable statement.

Referring back to FIG. 28, the description proceeds from step S137.

In step S137, the comparison unit 140 determines whether there is an unselected executable statement.

If there is an unselected executable statement, processing returns to step S133.

If there is no unselected executable statement, processing proceeds to step S138.

In step S138, the comparison unit 140 determines whether there is an unselected function.

If there is an unselected function, processing returns to step S131.

If there is no unselected function, the comparison processing (S130) ends.

### Advantageous Effects of Embodiment 1

When a change is made to software, a portion that is affected by the change can be not visually but automatically identified not in terms of a function but in terms of an executable statement or in terms of a row.

### Embodiment 2

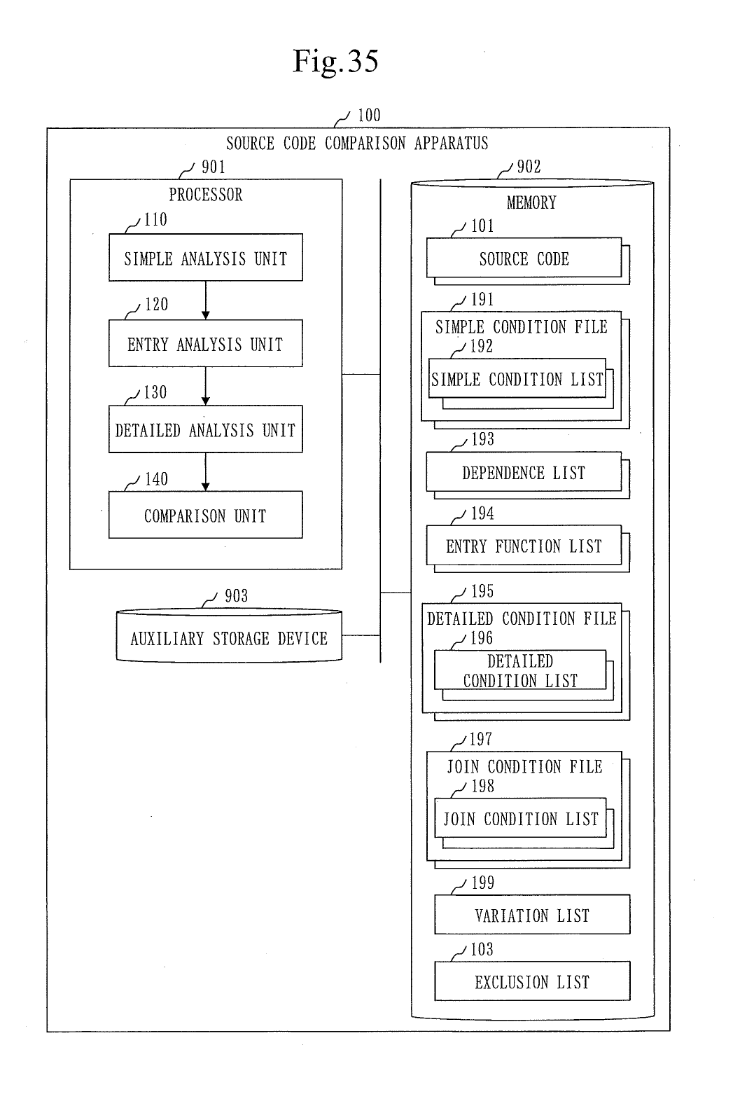

An embodiment which excludes a condition including a variable targeted for exclusion from a detailed precondition and a detailed postcondition is described based on FIG. 35 to FIG. 39. However, descriptions that overlap those in the embodiment 1 are omitted or simplified.

### Description of Configuration

A configuration of the source code comparison apparatus 100 is described based on FIG. 35.

The configuration of the source code comparison apparatus 100 is the same as that in the embodiment 1.

However, an exclusion list 103 is stored in the memory 902.

The exclusion list 103 is a list of variables targeted for exclusion.

### Description of Operation

The flow of processing for the source code comparison method is the same as that in the embodiment 1.

However, a part of recurrence analysis processing (S300) is different from that in the embodiment 1.

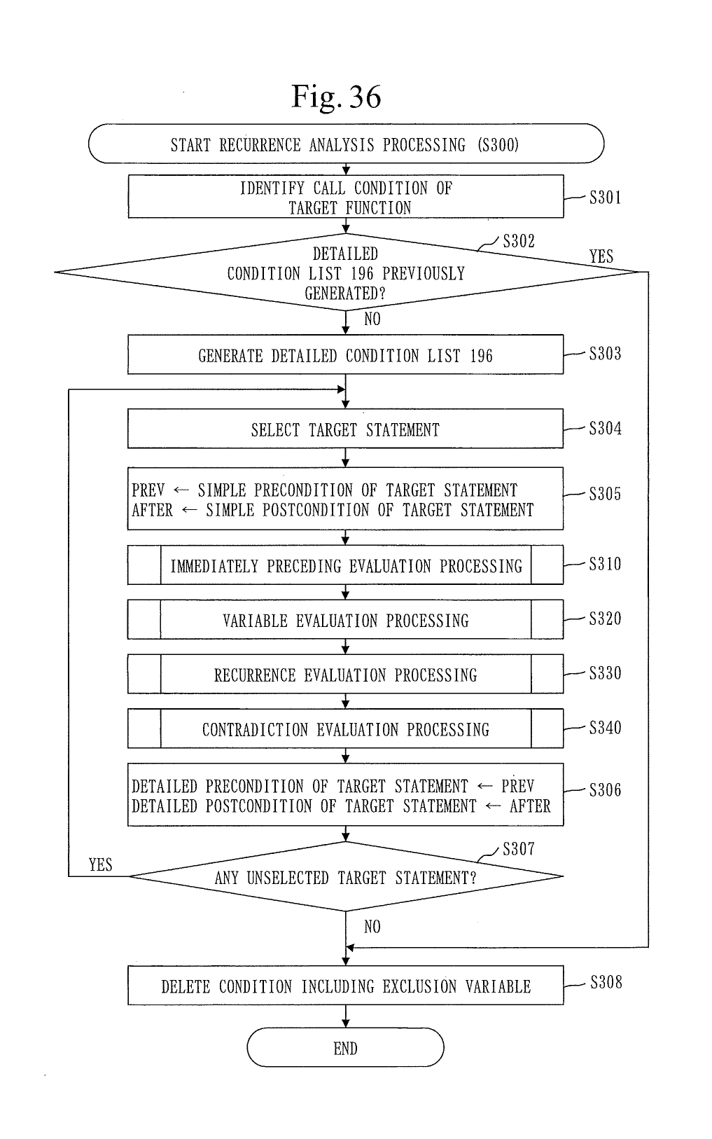

The recurrence analysis processing (S300) is described based on FIG. 36.

The recurrence analysis processing (S300) includes step S308. The other steps are the same as those in the embodiment 1.

In step S308, the detailed analysis unit 130 excludes a condition including a variable targeted for exclusion from the detailed precondition and the detailed postcondition included in the detailed condition list 196 of the target function.

More specifically, the detailed analysis unit 130 performs the following processing for each variable indicated in the exclusion list 103. The variable indicated in the exclusion list 103 is referred to as an exclusion variable.

The detailed analysis unit 130 searches for a detailed precondition including an exclusion variable and a detailed postcondition including an exclusion variable from the detailed condition list 196. The detailed precondition and the detailed postcondition are collectively referred to as a detailed condition. The detailed condition is configured with one or more conditional expressions. A plurality of conditional expressions is interconnected by a connection symbol (∪) meaning a logical sum or a connection symbol (∩) meaning a logical product.

If a detailed condition including an exclusion variable has been found, the detailed analysis unit 130 identifies a conditional expression including an exclusion variable by separating a conditional expression included in the detailed condition with a connection symbol used as a delimiter.

Then, the detailed analysis unit 130 deletes the identified conditional expression and a symbol attached in front of the identified conditional expression from the detailed condition including an exclusion variable.

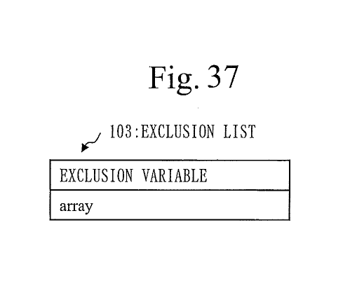

FIG. 37 illustrates the exclusion list 103.

In the exclusion list 103 illustrated in FIG. 37, the exclusion variable is “array”.

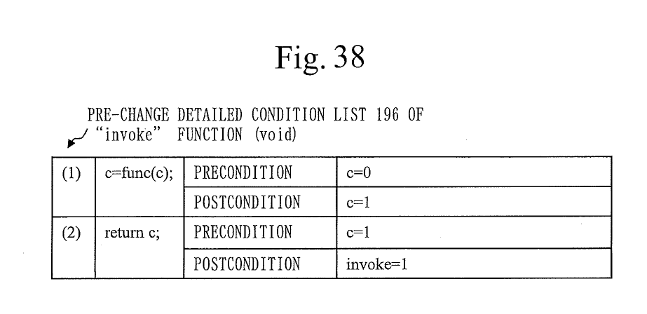

FIG. 38 illustrates a detailed condition list 196 obtained by excluding a condition including the exclusion variable (array) from the detailed condition list 196 illustrated in FIG. 21.

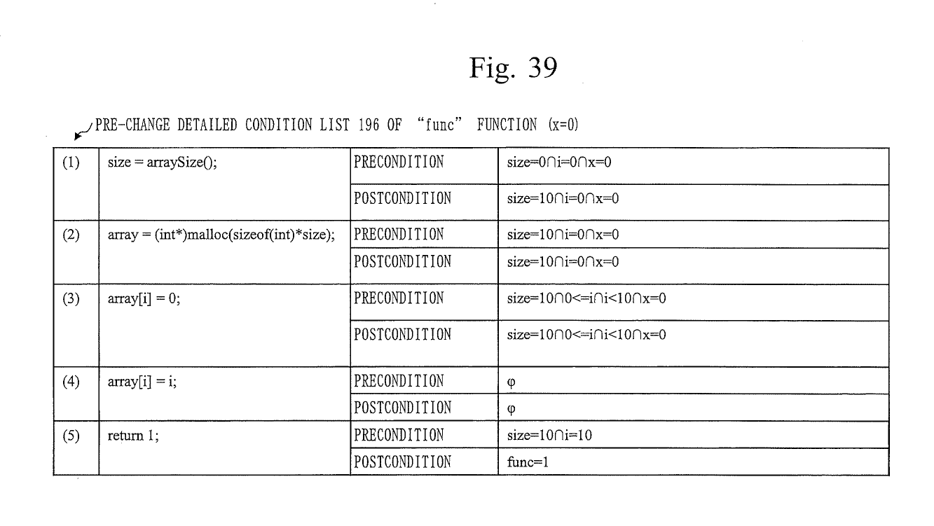

FIG. 39 illustrates a detailed condition list 196 obtained by excluding a condition including the exclusion variable from the detailed condition list 196 illustrated in FIG. 22.

FIG. 21 and FIG. 38 illustrate the detailed condition list 196 of the “invoke” function, and FIG. 22 and FIG. 39 illustrate the detailed condition list 196 of the “func” function.

In association with a condition including an exclusion variable being excluded from the detailed condition list 196 of the “func” function, which is called from the “invoke” function, a condition including the exclusion variable is excluded from the detailed condition list 196 of the “invoke” function, which is a call source of the “func” function.

### Advantageous Effects of Embodiment 2

A precondition and a postcondition which are included in the detailed condition list 196 can be abbreviated. In association with this, a precondition and a postcondition which are included in the variation list 199 are abbreviated. As a result, the accuracy of identifying a portion that is affected by a change is improved.

Some global variables include a variable which is referred to from only a specific function or a variable which is used as a temporary storage location for a value. In a case where these global variables are included in a precondition and a postcondition, in the variation list 199, a logical expression description of the precondition and a logical expression description of the postcondition become large. Then, a variation in value range of unnecessary global variables may appear as a change-affected portion.

On the other hand, in the embodiment 2, since a specific global variable is excluded from a precondition and a postcondition, in the variation list 199, the logical expression description of the precondition and the logical expression description of the postcondition are reduced. This enables increasing the accuracy of a change-affected range to be identified.

### Embodiment 3

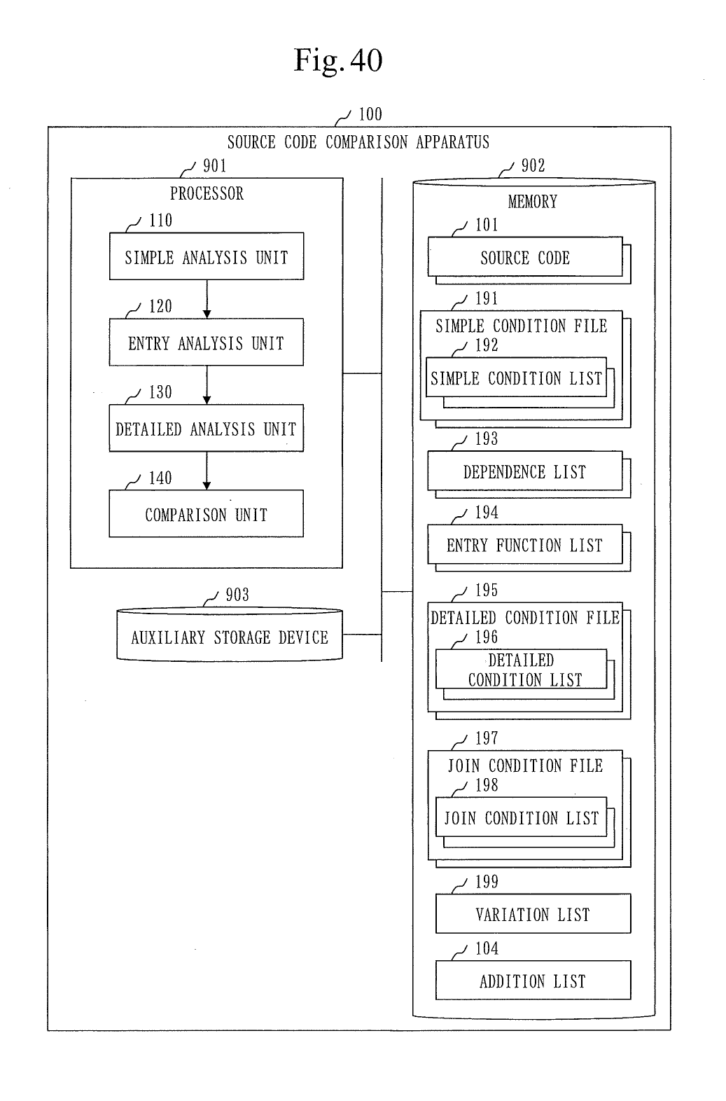

An embodiment which adds a condition of an argument about a standard function targeted for addition to a detailed postcondition is described based on FIG. 40 to FIG. 45. However, descriptions that overlap those in the embodiment 1 are omitted or simplified.

### Description of Configuration

A configuration of the source code comparison apparatus 100 is described based on FIG. 40.

The configuration of the source code comparison apparatus 100 is the same as that in the embodiment 1.

However, an addition list 104 is stored in the memory 902.

The addition list 104 is a list of standard functions targeted for addition.

The standard function is a function different from functions included in the source code 101, and is a function that is prepared as standard. A specific standard function is a malloc (memory allocation) function used to dynamically allocate memory.

### Description of Operation

The flow of processing for the source code comparison method is the same as that in the embodiment 1.

However, a part of recurrence analysis processing (S300) is different from that in the embodiment 1.

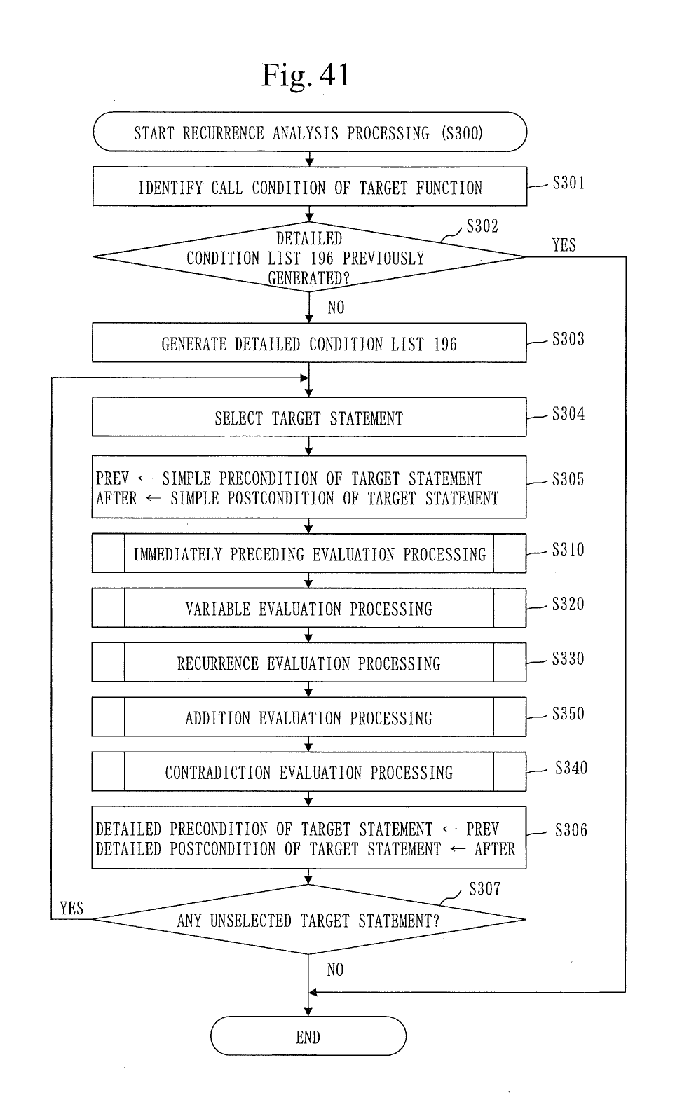

The recurrence analysis processing (S300) is described based on FIG. 41.

The recurrence analysis processing (S300) includes step S350. The other steps are the same as those in the embodiment 1.

Step S350 is addition evaluation processing.

In step S350, in a case where the target statement is an executable statement for calling a standard function targeted for addition, the detailed analysis unit 130 adds a condition that is met about an argument of the standard function to the work postcondition AFTER of the target statement.

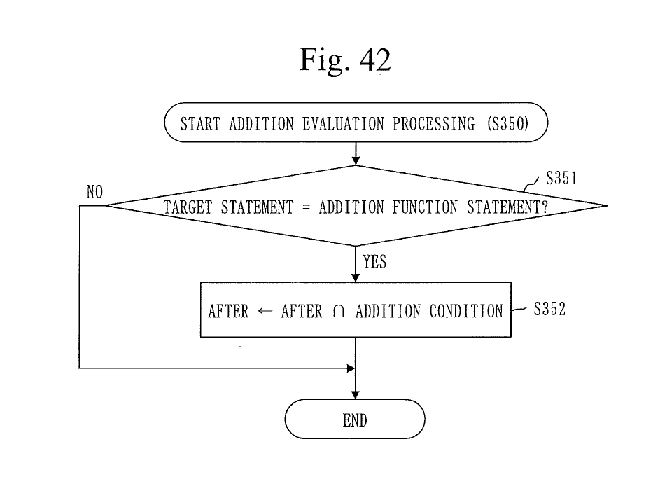

The addition evaluation processing (S350) is described based on FIG. 42.

In step S351, the detailed analysis unit 130 determines whether the target statement is an addition function statement. The addition function statement is an executable statement for calling an addition function which is a standard function targeted for addition.

More specifically, the detailed analysis unit 130 determines whether the name of a standard function indicated in the addition list 104 is included in the target statement. If the name of a standard function indicated in the addition list 104 is included in the target statement, the detailed analysis unit 130 determines that the target statement is an addition function statement.

If the target statement is an addition function statement, processing proceeds to step S352.

If the target statement is not an addition function statement, the addition evaluation processing (S350) ends.

In step S352, the detailed analysis unit 130 identifies a condition that is met about an argument of the addition function based on the target statement and the work precondition PREV of the target statement.

Then, the detailed analysis unit 130 adds the identified condition to the work postcondition AFTER of the target statement.

More specifically, the detailed analysis unit 130 performs the following processing.

The detailed analysis unit 130 acquires an argument of the addition function from the target statement.

If the argument of the addition function is a variable, the detailed analysis unit 130 determines whether a conditional expression including the variable as a left-hand side element is included in the work precondition PREV of the target statement.

If the above-mentioned conditional expression is included in the work precondition PREV of the target statement, the detailed analysis unit 130 replaces the variable, which is the argument of the addition function, with a right-hand side value of the above-mentioned conditional expression.

Next, the detailed analysis unit 130 generates an addition condition in which a variable or value that is an argument of the addition function is specified.

Next, the detailed analysis unit 130 generates a product set of the condition set to the work postcondition AFTER of the target statement and the addition condition.

Then, the detailed analysis unit 130 replaces the condition set to the work postcondition AFTER of the target statement with the generated product set.

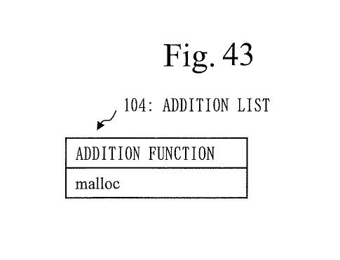

FIG. 43 illustrates the addition list 104.

In the addition list 104 illustrated in FIG. 43, the addition function is “malloc”.

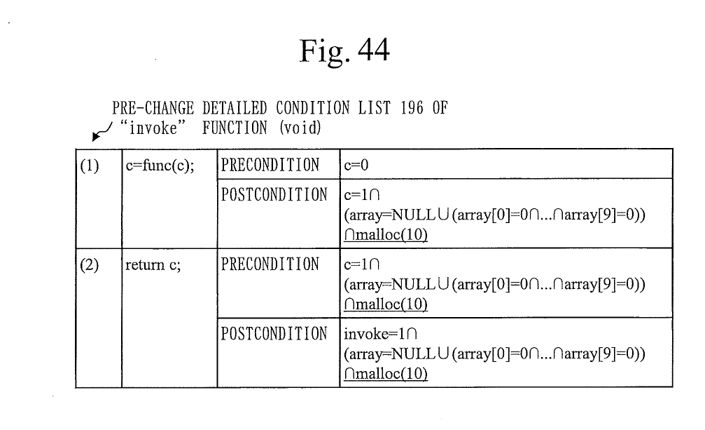

FIG. 44 illustrates a detailed condition list 196 obtained by adding a condition about an argument of the addition function (malloc) to the detailed condition list 196 illustrated in FIG. 21. In the detailed condition list 196 illustrated in FIG. 44, an underlined portion is a portion indicating the added condition.

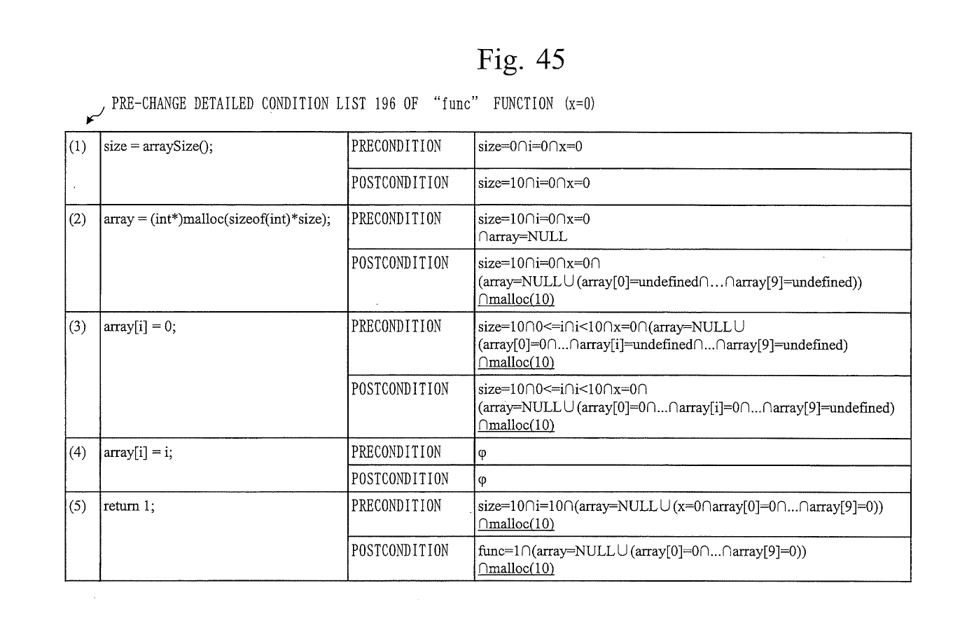

FIG. 45 illustrates a detailed condition list 196 obtained by adding a condition about an argument of the addition function to the detailed condition list 196 illustrated in FIG. 22. In the detailed condition list 196 illustrated in FIG. 45, an underlined portion is a portion indicating the added condition.

FIG. 21 and FIG. 44 illustrate the detailed condition list 196 of the “invoke” function, and FIG. 22 and FIG. 45 illustrate the detailed condition list 196 of the “func” function.

In association with a condition about an argument of the addition function being added to the detailed condition list 196 of the “func” function, which is called from the “invoke” function, a condition about an argument of the addition function is added to the detailed condition list 196 of the “invoke” function, which is a call source of the “func” function.

### Advantageous Effects of Embodiment 3

A precondition and a postcondition which are included in the detailed condition list 196 can be extended. In association with this, a precondition and a postcondition which are included in the variation list 199 are extended. As a result, the accuracy of identifying a portion that is affected by a change is improved.

There are functions the behavior of which varies with a value range of call parameters, such as a driver or an application program interface (API). In a case where the value range of arguments used when such a function is called is not included in the precondition and the postcondition, a variation in value range of the function may not be identified as a change-affected portion.

On the other hand, in the embodiment 3, since an argument of a specific function is added to a precondition and a postcondition, in the variation list 199, the logical expression description of the precondition and the logical expression description of the postcondition are extended. This enables increasing the accuracy of a change-affected range to be identified.

### Supplemental to Embodiments

In each embodiment, the functions of the source code comparison apparatus 100 can be implemented by hardware.

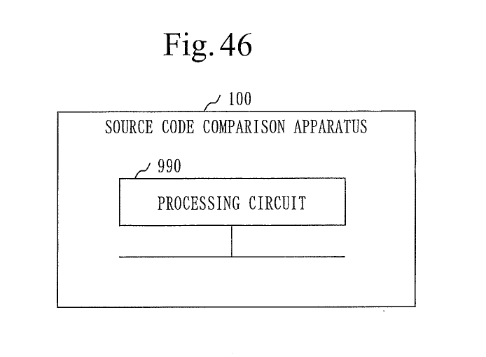

FIG. 46 illustrates a configuration in which the function of the source code comparison apparatus 100 is implemented by hardware.

The source code comparison apparatus 100 includes a processing circuit 990. The processing circuit 990 is also called a processing circuitry.

The processing circuit 990 is a dedicated electronic circuit which implements the functions of “units” described in each embodiment. The “units” also include a storage unit.

More specifically, the processing circuit 990 is a single circuit, a composite circuit, a programmed processor, a parallel programmed processor, a logic IC, a GA, an ASIC, an FPGA, or their combination. GA is an abbreviation for Gate Array, ASIC is an abbreviation for Application Specific Integrated Circuit, and FPGA is an abbreviation for Field Programmable Gate Array.

Furthermore, the source code comparison apparatus 100 can include a plurality of processing circuits 990, and the plurality of processing circuits 990 can implement the functions of “units” in cooperation with each other.

The function of the source code comparison apparatus 100 can be implemented by a combination of software and hardware. Thus, a part of “units” can be implemented by software, and the remaining part of the “units” can be implemented by hardware.

Each embodiment is merely an example of a desirable embodiment, and is not intended to limit the technical scope of the invention. Each embodiment can be carried out in part, or can be carried out in combination with another embodiment.

The procedures described with use of flowcharts and so on are examples of the procedures of a method and a program in each embodiment.

### REFERENCE SIGNS LIST

100: source code comparison apparatus, 101: source code, 102: function, 103: exclusion list, 104: addition list, 110: simple analysis unit, 120: entry analysis unit, 130: detailed analysis unit, 140: comparison unit, 191: simple condition file, 192: simple condition list, 193: dependence list, 194: entry function list, 195: detailed condition file, 196: detailed condition list, 197: join condition file, 198: join condition list, 199: variation list, 901: processor, 902: memory, 903: auxiliary storage device, 990: processing circuit.

1. A source code comparison apparatus comprising:
processing circuitry
to generate, with respect to pre-change source code and post-change source code, a detailed condition list in which, for each set of a function included in each piece of source code and a call condition that is met when the function is called, an executable statement included in the function, a detailed precondition that is met before the executable statement is executed under the call condition, and a detailed postcondition that is met after the executable statement is executed under the call condition are associated with each other; and
to generate a variation list including information for identifying an executable statement that differs in at least one of the detailed precondition and the detailed postcondition between the pre-change source code and the post-change source code based on a pre-change detailed condition list, which is the detailed condition list generated with respect to the pre-change source code, and a post-change detailed condition list, which is the detailed condition list generated with respect to the post-change source code.

2. The source code comparison apparatus according to claim 1, wherein the processing circuitry:
generates, with respect to the pre-change source code and the post-change source code, a simple condition list in which, for each function included in each piece of source code, an executable statement included in the function, a simple precondition that is met before the executable statement is executed, and a simple postcondition that is met after the executable statement is executed are associated with each other;
generates a pre-change detailed condition list based on the pre-change source code and a pre-change simple condition list, which is the simple condition list generated with respect to the pre-change source code; and
generates a post-change detailed condition list based on the post-change source code and a post-change simple condition list, which is the simple condition list generated with respect to the post-change source code.

3. The source code comparison apparatus according to claim 2,
wherein the processing circuitry:
identifies a call condition that is met when a target function, which is a function targeted for generating the detailed condition list, is called;
selects, from the simple condition list of the target function, an executable statement as a target statement in order in which executable statements are executed;
acquires, from the simple condition list of the target function, the simple precondition of the target statement and the simple postcondition of the target statement as the detailed precondition of the target statement and the detailed postcondition of the target statement which are registered with a detailed condition list corresponding to a set of the target function and the call condition; and
acquires, in a case where an immediately preceding statement, which is an executable statement that is executed prior to the target statement, is included the target function, the detailed postcondition of the immediately preceding statement from the detailed condition list corresponding to a set of the target function and the call condition, and adds the detailed postcondition of the immediately preceding statement to the detailed precondition of the target statement.

4. The source code comparison apparatus according to claim 3,
wherein, in a case where a condition including an element which is replaced with a value included in the call condition of the target function or a value included in the detailed postcondition of the immediately preceding statement is included in the detailed precondition of the target statement or the detailed postcondition of the target statement, the processing circuitry replaces the element with the value included in the call condition of the target function or the value included in the detailed postcondition of the immediately preceding statement.

5. The source code comparison apparatus according to claim 3,
wherein, in a case where the target statement is an executable statement for calling a function, the processing circuitry generates the detailed condition list with respect to a call destination function, which is a function that is called by the target statement, identifies a condition that is met after the call destination function is executed based on the detailed condition list of the call destination function, and replaces the detailed postcondition of the target statement with the identified condition.

6. The source code comparison apparatus according to claim 3,
wherein, in a case where the target statement is an executable statement for calling a standard function targeted for addition, the processing circuitry adds a condition that is met about an argument of the standard function to the detailed postcondition of the target statement.

7. The source code comparison apparatus according to claim 3,
wherein the processing circuitry determines whether there is a contradiction in the detailed precondition of the target statement, and if determining that there is a contradiction in the detailed precondition of the target statement, deletes a condition obtained as the detailed precondition of the target statement and a condition obtained as the detailed postcondition of the target statement.

8. The source code comparison apparatus according to claim 3,
wherein the processing circuitry
identifies an entry function, which is a function that calls at least any one of functions but is not called from any function, and
sets the entry function as an initial target function, and generates the detailed condition list of the entry function and the detailed condition list of a function that is called in association with execution of the entry function.

9. The source code comparison apparatus according to claim 1,
wherein the processing circuitry excludes a condition including a variable targeted for exclusion from the detailed precondition and the detailed postcondition.

10. A non-transitory computer readable recording medium storing a source code comparison program for causing a computer to execute:
detailed analysis processing to generate, with respect to pre-change source code and post-change source code, a detailed condition list in which, for each set of a function included in each piece of source code and a call condition that is met when the function is called, an executable statement included in the function, a detailed precondition that is met before the executable statement is executed under the call condition, and a detailed postcondition that is met after the executable statement is executed under the call condition are associated with each other; and
comparison processing to generate a variation list including information for identifying an executable statement that differs in at least one of the detailed precondition and the detailed postcondition between the pre-change source code and the post-change source code based on a pre-change detailed condition list, which is the detailed condition list generated with respect to the pre-change source code, and a post-change detailed condition list, which is the detailed condition list generated with respect to the post-change source code.
